(19) United States
(12) Patent Application Publication
(10) Pub. No.: US 2025/0126553 A1
(43) Pub. Date: Apr. 17, 2025

(54) METHOD FOR SAVING ENERGY, TERMINAL, AND NETWORK DEVICE

(71) Applicant: GUANGDONG OPPO MOBILE TELECOMMUNICATIONS CORP., LTD., Dongguan (CN)

(72) Inventors: Zhe FU, Dongguan (CN); Yi HU, Dongguan (CN)

(21) Appl. No.: 19/002,962

(22) Filed: Dec. 27, 2024

Related U.S. Application Data
(63) Continuation of application No. PCT/CN2022/111520, filed on Aug. 10, 2022.

(30) Foreign Application Priority Data
Aug. 5, 2022 (WO) PCT/CN2022/110715

(51) Int. Cl. H04W 52/02; H04W 36/00; H04W 76/28

(52) U.S. Cl. CPC H04W 52/0203; H04W 36/0061; H04W 76/28

(57) ABSTRACT

Provided is a method for saving energy, which is applicable to a terminal. The method includes performing an operation associated with network energy saving. Provided further is a terminal. The terminal includes: a processor, a transceiver connected to the processor, and a memory configured to store one or more runnable programs of the processor, where the processor, when loading and running the one or more runnable programs, is caused to perform an operation associated with network energy saving.

### CROSS-REFERENCE TO RELATED APPLICATIONS

This application is a continuation application of international application No. PCT/CN2022/111520, filed on Aug. 10, 2022, which claims the priority to Patent Application No. PCT/CN2022/110715 filed on Aug. 5, 2022 and entitled “METHOD AND APPARATUS FOR SAVING ENERGY, AND DEVICE AND STORAGE MEDIUM,” the contents of which are incorporated herein by reference in their entireties.

### TECHNICAL FIELD

The present disclosure relates to the field of communications, and in particular, relates to a method and an apparatus for saving energy, a device, and a storage medium.

### BACKGROUND

Energy consumption has become an important part of operators' operating costs, with energy costs of mobile networks accounting for about 23% of operators' total costs. Most of the energy consumption comes from the radio access network, particularly the active antenna unit (AAU).

However, the current energy saving research mainly focuses on terminals, and there is no research on network energy saving technologies.

### SUMMARY

Embodiments of the present disclosure provide a method for saving energy, a terminal, and a network device.

According to some embodiments of the present disclosure, a method for saving energy is provided. The method is applicable to a terminal, and includes:
performing an operation associated with network energy saving.

According to some embodiments of the present disclosure, a method for saving energy is provided. The method is applicable to a network, and includes:
performing an operation associated with network energy saving.

According to some embodiments of the present disclosure, a terminal is provided. The terminal includes: a processor, a transceiver connected to the processor, and a memory configured to store one or more runnable programs on the processor, where the processor, when loading and running the one or more runnable programs, is caused to perform the method for saving energy as described above.

According to some embodiments of the present disclosure, a network device is provided. The network device includes: a processor, a transceiver connected to the processor, and a memory configured to store one or more runnable programs of the processor, where the processor, when loading and running the one or more runnable programs, is caused to perform the method for saving energy as described above.

### BRIEF DESCRIPTION OF THE DRAWINGS

For describing the technical solutions in the embodiments of the present disclosure more clearly, the following briefly describes the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 illustrates a schematic diagram of a system message update in the related art;

FIG. 2 illustrates a schematic flowchart of a conditional handover process in the related art;

FIG. 3 illustrates a schematic diagram of a communication system according to some schematic embodiments of the present disclosure;

FIG. 4 illustrates a schematic flowchart of a method for saving energy according to some schematic embodiments of the present disclosure;

FIG. 5 illustrates a schematic flowchart of a method for saving energy according to some schematic embodiments of the present disclosure;

FIG. 6 illustrates a schematic flowchart of a method for saving energy according to some schematic embodiments of the present disclosure;

FIG. 7 illustrates a schematic flowchart of a method for saving energy according to some schematic embodiments of the present disclosure;

FIG. 8 illustrates a schematic diagram of a method for saving energy according to some schematic embodiments of the present disclosure;

FIG. 9 illustrates a schematic flowchart of a method for saving energy according to some schematic embodiments of the present disclosure;

FIG. 10 illustrates a schematic flowchart of a method for saving energy according to some schematic embodiments of the present disclosure;

FIG. 11 illustrates a schematic flowchart of a method for saving energy according to some schematic embodiments of the present disclosure;

FIG. 12 illustrates a schematic flowchart of a method for saving energy according to some schematic embodiments of the present disclosure;

FIG. 13 illustrates a schematic structural diagram of a first information according to some schematic embodiments of the present disclosure;

FIG. 14 illustrates a schematic structural diagram of a first information according to some schematic embodiments of the present disclosure;

FIG. 15 illustrates a schematic diagram of a method for saving energy according to some schematic embodiments of the present disclosure;

FIG. 16 illustrates a schematic diagram of a method for saving energy according to some schematic embodiments of the present disclosure;

FIG. 17 illustrates a schematic flowchart of a method for saving energy according to some schematic embodiments of the present disclosure;

FIG. 18 illustrates a schematic flowchart of a method for saving energy according to some schematic embodiments of the present disclosure;

FIG. 19 illustrates a schematic flowchart of a method for saving energy according to some schematic embodiments of the present disclosure;

FIG. 20 illustrates a schematic diagram of a method for saving energy according to some schematic embodiments of the present disclosure;

FIG. 21 illustrates a schematic flowchart of a method for saving energy according to some schematic embodiments of the present disclosure;

FIG. 22 illustrates a schematic flowchart of a method for saving energy according to some schematic embodiments of the present disclosure;

FIG. 23 illustrates a schematic diagram of a CG/SPS configuration according to some schematic embodiments of the present disclosure;

FIG. 24 illustrates a schematic diagram of an architecture according to some schematic embodiments of the present disclosure;

FIG. 25 illustrates a structural block diagram of an apparatus for saving energy according to some schematic embodiments of the present disclosure;

FIG. 26 illustrates a structural block diagram of an apparatus for saving energy according to some schematic embodiments of the present disclosure; and

FIG. 27 illustrates a schematic structural diagram of a device for saving energy according to some schematic embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings. Reference is made in detail to the exemplary embodiments, examples of which are illustrated in the accompanying drawings. When the following description refers to the accompanying drawings, the same numbers in different accompanying drawings represent the same or similar elements unless otherwise indicated. The embodiments described in the following exemplary embodiments do not represent all embodiments consistent with the present disclosure. Rather, they are merely examples of apparatus and methods consistent with certain aspects of the present disclosure, as detailed in the appended claims.

The terms used in the present disclosure are for the purpose of describing particular embodiments only and are not intended to be limiting to the present disclosure. As used in the present disclosure and the appended claims, the singular forms “a”, “an”, and “the” are intended to include the plural forms as well, unless the context clearly indicates otherwise. It should also be understood that the term “and/or” as used herein refers to and encompasses any or all possible combinations of one or more associated listed items.

It should be understood that although the terms “first”, “second”, “third”, etc. may be used herein to describe various information, such information should not be limited to these terms. These terms are only used to distinguish one type of information from another. For example, first information may also be referred to as second information, and similarly, second information may also be referred to as first information, without departing from the scope of the present disclosure. The word “if”, as used herein, may be interpreted as “in the case that”, “in the case of”, or “in response to determining that”, depending on the context.

First, the related technologies involved in the embodiments of the present disclosure are described as follows.

With the pursuit of speed, delay, high-speed mobility, energy efficiency, and the diversity and complexity of communication services in future life, the 3rd Generation Partnership Project (3GPP) International Standards Organization has begun to develop a 5th-generation (5G) mobile communication technology. The main application scenarios of 5G are as follows: enhanced mobile broadband (eMBB), ultra reliable low latency communication (URLLC), and massive machine type of communication (mMTC).

The eMBB continues to target the delivery of multimedia content, services, and data to users, with a rapidly growing demand. In addition, since the eMBB may be deployed in different scenarios, e.g., indoor, urban, and rural scenarios, and the difference between the capabilities and the requirements is large, it cannot be generalized and must be analyzed in detail in conjunction with the specific deployment scenario. Typical applications of URLLC include: industrial automation, power automation, remote medical operations (surgery), traffic safety, and the like. Typical characteristics of mMTC include: high connection density, small data volume, delay-insensitive service, low cost of module, long service life, and the like.

A new radio (NR) may also be deployed independently, and in order to reduce radio signaling, quickly recover wireless connection, and quickly recover data services in a 5G network environment, a new radio resource control (RRC) state, i.e., an RRC_INACTIVE state, is defined. This state is distinguished from an RRC_IDLE state and an RRC_ACTIVE state.

In RRC_IDLE: the mobility is cell selection and reselection based on user equipment (UE), paging is initiated by a core network (CN), and a paging region is configured by the CN. The base station side does not have a UE access stratum (AS) context and an RRC connection.

In RRC_CONNECTED: an RRC connection is present, and the base station and the UE have a UE AS context. The network side knows that the location of the UE is of a specific cell level. The mobility is network side controlled mobility. Unicast data may be transmitted between the UE and the base station.

In RRC_INACTIVE: the mobility is UE-based cell selection and reselection, a connection is present between CN-NR, a UE AS context is present on a certain base station, paging is triggered by a radio access network (RAN), an RAN-based paging region is managed by RAN, and the network side knows that the location of the UE is of an RAN-based paging region level.

### Bandwidth Part (BWP) Technology

In order to provide a higher data transmission rate and improve user experience, 5G NR further increases the system bandwidth on the basis of 4G. In 5G NR, the maximum bandwidth supported by a single carrier is 100 MHz for frequency bands below 6 GHz; and the maximum bandwidth supported by a single carrier is 400 MHz for frequency bands above 6 GHz. For a large carrier bandwidth, such as 100 HMz, the bandwidth that the terminal needs to use is often very limited, and in the case that the terminal is allowed to detect and measure on the whole bandwidth all the time, it will bring a great challenge to power consumption of the terminal, which is not favorable for the terminal to save power. Therefore, the concept of a BWP is introduced into 5G NR, that is, a part of continuous bandwidth is extracted from the large overall carrier bandwidth for the terminal to perform data transmission. The terminal only needs to perform relevant operations in the bandwidth part configured by the network, thereby achieving the effect of energy saving of the terminal.

Based on the related specification of the 5G NR, for each serving cell of the terminal, the network may configure one or more BWPs on the serving cell for the terminal over an RRC re-configuration message, where the maximum configurable number of BWPs is 4. At each time, the terminal may only have one activated downlink (DL) BWP and one activated uplink (UL) BWP in the serving cell, and the terminal may only perform data transmission on the activated BWPs. The terminal may have a need to adjust BWPs in consideration of the diversity of the terminal services and the differences between different service properties. For example, in the case that the traffic of the terminal is large, the terminal wants to acquire a high-rate service, and needs to use a BWP with a large bandwidth for data transmission. In the case that the traffic of the terminal is small, the terminal may use a BWP with a small bandwidth for data transmission. The BWP activated by the terminal in the serving cell may be changed by using a BWP switching method. Currently, four BWP switching methods supported in the relevant standards are as follows:

### 1. BWP Switching Performed Based on a Physical Downlink Control Channel (PDCCH)

The BWP switching is controlled by a network. The network informs a single terminal of a target BWP for switch by transmitting a cell-radio network temporary identifier (C-RNTI) scrambled PDCCH to the single terminal.

### 2. BWP Switching Performed Based on RRC (Re-Configuration) Configuration

The BWP switching is controlled by a network. By including firstActiveDownlinkBWP-Id or/and firstActiveUplinkBWP-Id in the RRC (re-configuration) configuration message, the network indicates the terminal to switch the activated BWP into firstActiveDownlinkBWP-Id or/and firstActiveUplinkBWP-I.

### 3. BWP Switching Performed Based on Timer Timeout

This is an implicit BWP switching method. The network side configures a timer bwp-InactivityTimer for each serving cell of the terminal. In the case that the currently activated DL BWP of the terminal is a BWP other than the default BWP and the initial DL BWP, the timer bwp-InactivityTimer is started or restarted each time the terminal receives a PDCCH indicating uplink or downlink scheduling for the UE on the currently activated BWP. When the timer bwp-InactivityTimer times out, the terminal automatically switches to a default BWP or an initial DL BWP, where both the default BWP and the initial BWP are determined by an RRC configuration.

### 4. BWP Switching Caused by Random Access Initialization

In the random access channel (RACH) initialization process, in the case that the terminal does not configure a physical random access channel (PRACH) occasion on the currently activated UL BWP, the terminal automatically switches the UL BWP to an initial UL BWP, and simultaneously switches the DL BWP to an initial DL BWP.

### System Message Modification

In the long-term evolution (LTE) and NR systems, the concept of a system message modification period is employed. In the case that a network needs to modify system messages, it first repeatedly transmits a system message modification indication during the n^{th} system message modification period, followed by the repeated transmission of the changed system messages in the (n+1)^{th} system message modification period. The boundaries of the system message modification period are defined as the system frame number (SFN) satisfying SFN mod m=0, where m represents the number of SFNs contained in one system message modification period (MP). m=modificationPeriodCoeff*defaultPagingCycle, where modificationPeriodCoeff and defaultPagingCycle are a system message modification period coefficient and a default paging period, respectively, and these 2 parameters are determined by network broadcast. A schematic diagram of system message modification is illustrated in FIG. 1.

In the NR System, the system message modification period is applicable to the modification of system messages other than system information block (SIB) 6, SIB7, SIB8, and positioning assistance data. In the NR, a short message in paging downlink control information (DCI) is configured to notify a system information modification indication, and a PDCCH where the paging DCI is located is scrambled by a paging-RNTI.

In the case that the value of systemInfoModification in the short message is 1, it indicates that other system messages than SIB6, SIB7, and SIB8 are to be modified, and the terminal acquires the modified system message in the next system message modification period.

In the case that the value of etwsAndCmasIndication in the short message is 1, it indicates that the network is about to transmit an earthquake and tsunami warning system (ETWS) and/or commercial mobile alert system (CMAS) notification, and the terminal re-reads SIB1, SIB6, SIB7, and SIB8 immediately after receiving the short message.

### Conditional Handover (CHO)

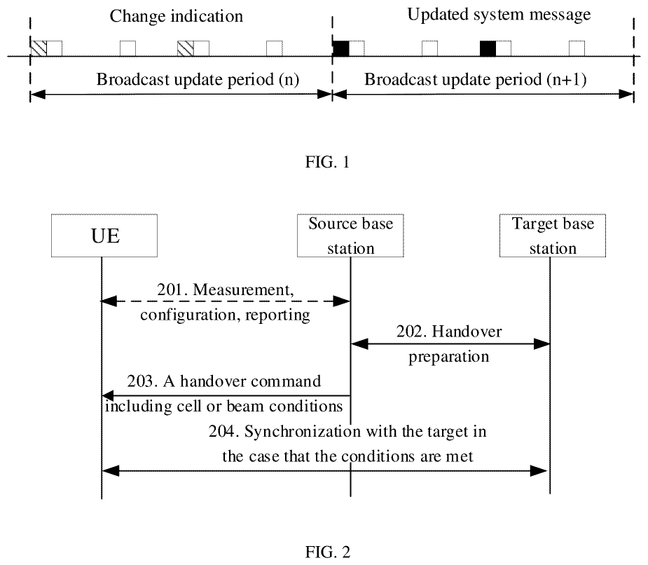

To address the issues of frequent handovers and the likelihood of handover failures in high-speed mobility scenarios and high-frequency deployment environments, LTE and NR systems in the related art introduce a CHO, as illustrated in FIG. 2. The basic principle is that a base station pre-assigns a target cell to a terminal (201), and a condition for triggering UE to switch is contained in an HO command (203); the UE performs the handover to the target cell according to a pre-configured handover command when evaluating the condition trigger associated with the target cell based on the condition configured on the network side (204), that is, a random access process is triggered and a handover completion message is transmitted, thereby avoiding the problem that it is too late or impossible to transmit the measurement report or receive the handover command due to high-speed mobility entering areas with poor coverage.

For CHO, the network may configure multiple candidate target cells in a handover command (HO command) and separately configure CHO execution conditions for each candidate target cell, which may include 1 or 2 triggering events. A3 and A5 events can be used for CHO events in the related art, and A4 event has also been agreed upon as a CHO event in the related art. The terminal determines which target cell to access based on the configured CHO execution conditions.

The measurement events currently supported in NR include the following:
A1 event: the signal quality of a serving cell is higher than a threshold;
A2 event: the signal quality of the serving cell is less than a threshold;
A3 event: the signal quality of a neighbor cell is higher than the signal quality of a special cell (SpCell) by a threshold;
A4 event: the signal quality of the neighbor cell is higher than a threshold;
A5 event: the signal quality of the SpCell is less than a threshold 1 and the signal quality of the neighbor cell is higher than a threshold 2;
A6 event: the signal quality of the neighbor cell is higher than the signal quality of a secondary cell (SCell) by a threshold;
B1 event: the signal quality of a neighbor cell using a different technology is higher than a threshold; and
B2 event: the signal quality of the primary cell (PCell) is less than a threshold 1 and the signal quality of a neighbor cell using a different technology is higher than a threshold 2.

### Conditional Primary Secondary Cell (PSCell) Change (CPC)

To address the issues of frequent PSCell changes in high-speed mobility scenarios and high-frequency deployment environments, a conditional PSCell change process is introduced for LTE and NR systems in the related art. The basic principle is that a secondary node (SN) pre-assigns a target cell to a terminal, which includes conditions for triggering the terminal to change the PSCell; the terminal evaluates the conditions configured on the network side, and in the case that the allocated condition is satisfied, the terminal initiates the PSCell change, thereby avoiding the problem that it is too late or impossible to transmit the measurement report or receive the PSCell change command due to high-speed mobility entering areas with poor coverage.

Similar to CHO, for CPC, the network may configure multiple candidate target cells for the terminal, and separately configure CPC execution conditions for each candidate target cell, which may include 1 or 2 triggering events. A3 and A5 events can be used for CPC events in the related art. The terminal determines which target cell to access based on the configured CPC execution conditions.

### Network Energy Saving Project

Energy consumption has become an important part of operators' operating costs. According to related reports, the energy costs of mobile networks account for about 23% of operators' total costs. Most of the energy consumption comes from the radio access network, particularly the active antenna unit (AAU), while data centers and fiber transmission only account for a small portion. Radio access network power consumption includes two types:
a dynamic part: e.g., consumption during data transmission/reception; and
a static part: e.g., consumption to maintain the necessary operation of radio access devices even when no data transmission/reception is ongoing.

Research on network energy saving projects should not only evaluate the potential benefits for network energy consumption but also evaluate and balance the impact on network and user performance. For example, the research should not significantly affect some key performance indicators (KPIs), such as spectral efficiency, capacity, user perceived throughput (UPT), delay, terminal power consumption, complexity, handover performance, call drop rate, and initial access performance.

However, most of the current research is directed to the energy saving technology of the terminal, and the issue of network energy saving is not considered. Moreover, there has been no discussion on how technologies such as CHO and BWP switching can support or integrate with the network energy saving technology.

Therefore, the present disclosure provides a method for saving energy, which aims at the research of the network energy saving technology. The method for saving energy provided by the present disclosure is illustrated below by means of schematic embodiments.

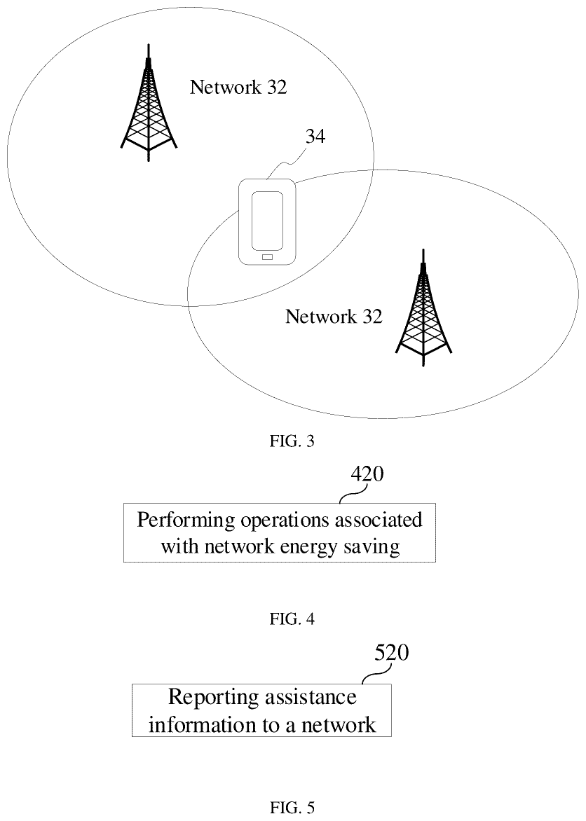

FIG. 3 illustrates a block diagram of a communication system according to some embodiments of the present disclosure. The communication system includes a network (NW) 32 and a terminal 34.

The network 32 in the present disclosure provides a wireless communication function, and the network 32 includes but is not limited to: an evolved node B (eNB), a radio network controller (RNC), a node B (NB), a base station controller (BSC), a base transceiver station (BTS), a home base station (e.g., a home evolved node B or a home node B (HNB)), a baseband unit (BBU), an access point (AP) in a wireless fidelity (Wi-Fi) system, a wireless relay node, a wireless backhaul node, a transmission point (TP), or a transmission and reception point (TRP). The network 32 may also be a next generation node B (gNB) or a transmission point (TRP or TP) in a 5G system; or may be an antenna panel or a group of antenna panels (including a plurality of antenna panels) in a 5G system; or may also be a network node forming a gNB or a transmission point, e.g., a base band unit (BBU) or a distributed unit (DU); or a base station, or the like, or a core network (CN), fronthaul, backhaul, a radio access network (RAN), a network slice, or the like, or a serving cell, Pcell, Pscell, SpCell, SCell, a neighbor cell, or the like of a terminal in a 6G communication system.

In the present disclosure, the terminal 34 may also be referred to as a user equipment (UE), an access terminal, a subscriber unit, a subscriber station, a mobile station, a mobile terminal, a remote station, a remote terminal, a mobile device, a user terminal, a terminal, a wireless communication device, a user agent, or a user apparatus. The terminal includes but is not limited to: a handheld device, a wearable equipment, a vehicle-mounted device, an IoT device, and the like, e.g., a mobile phone, a tablet computer, an e-book reader, a laptop portable computer, a desktop computer, a television, a game console, a mobile Internet device (MID), an augmented reality (AR) terminal, a virtual reality (VR) terminal, and a mixed reality (MR) terminal, a wearable device, a handle, an electronic tag, a controller, a wireless terminal in industrial control, a wireless terminal in self driving, a wireless terminal in remote medical, a wireless terminal in a smart grid, a wireless terminal in transportation safety, a wireless terminal in a smart city, a wireless terminal in a smart home, a wireless terminal in remote medical surgery, a cellular phone, a cordless phone, a session initiation protocol (SIP) phone, a wireless local loop (WLL) station, a personal digital assistant (PDA), a set top box (STB), a customer premise equipment (CPE), or the like.

The network 32 and the terminal 34 communicate with each other through a certain radio interface technology, such as a Uu interface.

Exemplarily, there are two communication scenarios between the network 32 and the terminal 34: an uplink communication scenario and a downlink communication scenario. The uplink communication refers to transmitting signals to the network 32, and the downlink communication refers to transmitting signals to the terminal 34.

The technical solutions provided by the embodiments of the present disclosure are applicable to various communication systems, e.g., a global system of mobile communication (GSM) system, a code division multiple access (CDMA) system, a wideband code division multiple access (WCDMA) system, a general packet radio service (GPRS), a long term evolution (LTE) system, an LTE frequency division duplex (FDD) system, an LTE time division duplex (TDD) system, an advanced long term evolution (LTE-A) system, a universal mobile telecommunication system (UMTS), a worldwide interoperability for microwave access (WiMAX) communication system, a 5th-generation (5G) mobile communication system, a new radio (NR) system, an evolved system of the NR system, an LTE-based access to unlicensed spectrum (LTE-U) system, an NR-based access to unlicensed spectrum (NR-U) system, a non-terrestrial networks (NTN) system, wireless local area networks (WLANs), wireless fidelity (Wi-Fi), a cellular IoT system, a cellular passive IoT system, and are also applicable to a subsequent evolved system of a 5G NR system, and are further applicable to a 6G system and a subsequent evolved system thereof. In some embodiments of the present disclosure, “NR” is also referred to as a 5G NR system or a 5G system. The 5G mobile communication system includes a non-standalone (NSA) and/or a standalone (SA).

The technical solutions provided in the embodiments of the present disclosure are also applicable to machine type communication (MTC), long term evolution-machine (LTE-M) technology, device to device (D2D) network, machine to machine (M2M) network, Internet of Things (IoT) network, or other networks. The IoT network may include, for example, Internet of Vehicles. The communication modes in the Internet of Vehicles system are collectively referred to as vehicle to X (V2X, X may represent anything); for example, the V2X may include: vehicle to vehicle (V2V) communication, vehicle to infrastructure (V2I) communication, vehicle to pedestrian (V2P) communication, vehicle to network (V2N) communication, or the like.

FIG. 4 illustrates a schematic flowchart of a method for saving energy according to some embodiments of the present disclosure. For example, the method is applicable to a terminal, and therefore the method includes at least part of the following steps.

In step 420, an operation associated with network energy saving is performed.

The terminal of the present disclosure includes at least one of the following:
a terminal in a first communication protocol version, optionally, the first communication protocol version including a 3GPP R18 version and/or a subsequent version of the 3GPP R18 version and/or a subsequent version of the 3GPP;
a terminal with network energy saving purposes;
a terminal instructed to report assistance information used for assisting network energy saving;
a terminal having reported assistance information used for assisting network energy saving;
a terminal accessing the current cell;
a terminal residing in the current cell;
a terminal configured to a specific group;
a terminal designated to a specific group;
a terminal having reported network energy saving capability;
a terminal having reported network energy saving requirements;
a connected state terminal; or
a non-connected state terminal.

The non-connected state terminal includes an idle terminal and/or an inactive terminal.

The network of the present disclosure includes at least one of the following:
a base station;
a base station corresponding to a serving cell of the terminal;
a base station corresponding to a primary cell of the terminal;
a base station corresponding to a primary secondary cell of the terminal;
a serving cell of the terminal;
a primary cell of the terminal;
a primary secondary cell of the terminal;
a neighbor base station;
a neighbor cell of the terminal;
a cell in an automatic neighbor relation (ANR) list; or
a base station in the ANR list.

In the present disclosure, the operations associated with network energy saving include at least one of the following:
reporting assistance information to the network. For example, the assistance information is used for assisting network energy saving;
performing data transmission and/or signaling transmission and/or system information transmission based on network configurations. For example, at least one of the network configurations is associated with network energy saving;
performing data transmission and/or signaling transmission and/or system information transmission based on network states. For example, at least one of the network states is associated with network energy saving;
performing data transmission and/or signaling transmission and/or system information transmission based on network state changes. For example, at least one of the changed network states is associated with network energy saving;
performing data transmission and/or signaling transmission and/or system information transmission based on discontinuous transmission (DTX) configurations and/or discontinuous reception (DRX) configurations. For example, at least one of the network DTX configurations and/or the network DRX configurations is associated with network energy saving;
performing bandwidth part (BWP) switching based on first information. For example, at least one piece of information in the first information is associated with network energy saving, or at least one piece of information in the first information is associated with network states, or at least one piece of information in the first information is associated with network configurations, or at least one piece of information in the first information is determined based on network energy saving; for example, the BWP switching is specific to one of a cell, a UE, and a UE group;
performing DRX transmission or reception based on DRX parameters and/or DRX configurations, which are specific to the terminal; or
performing cell handover based on cell handover information, which is terminal group handover information or cell level handover information.

In some embodiments, in the case that one configured grant (CG) period is configured with a non-integer period or a non-integer parameter, a physical uplink shared channel (PUSCH) opportunity is calculated based on a first formula. The parameter associated with the CG period in the first formula is rounded up or rounded down.

In some embodiments, in the case that one semi-persistent scheduling (SPS) period is configured with a non-integer period or a non-integer parameter, a physical downlink shared channel (PDSCH) opportunity is calculated based on a second formula. The parameter associated with the SPS period in the second formula is rounded up or rounded down.

In summary, in the method according to the embodiments, the terminal performs the operations associated with network energy saving to achieve the purpose of network energy saving.

FIG. 5 illustrates a schematic flowchart of a method for saving energy according to some exemplary embodiments of the present disclosure. For example, the method is applicable to a terminal, and therefore the method includes at least part of the following steps.

In step 520, assistance information is reported to a network.

Exemplarily, the network performs associated operations by using the assistance information. Exemplarily, the assistance information is used for assisting network energy saving and/or scheduling/resource allocation.

For example, a connected state UE, a UE with reporting capability, or the aforementioned UE reports the assistance information to the network.

In some embodiments, before step 520, the terminal receives a network request to report assistance information, or the terminal receives a network indication to report assistance information.

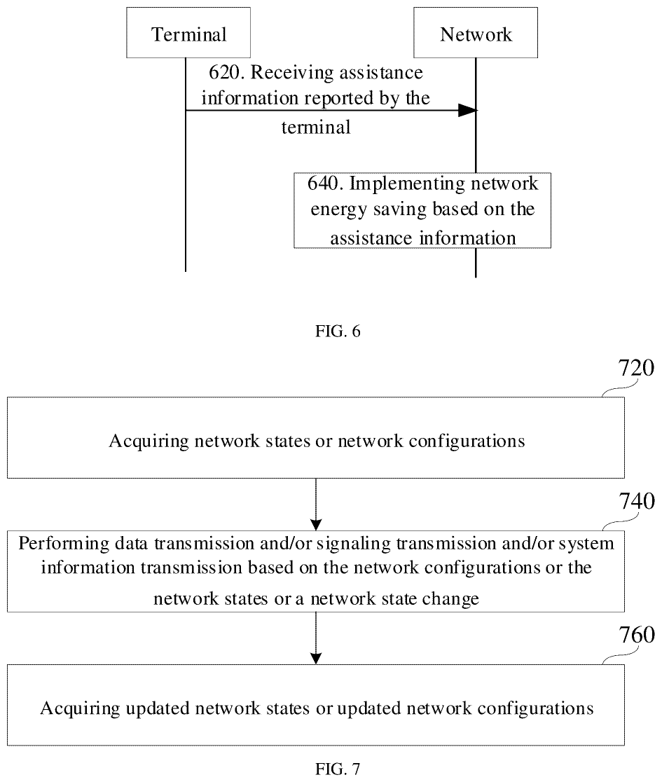

FIG. 6 illustrates a schematic flowchart of a method for saving energy according to some exemplary embodiments of the present disclosure. For example, the method is applicable to a network, and therefore the method includes at least part of the following steps.

In step 620, assistance information reported by a terminal is received.

Exemplarily, the network performs associated operations by using the assistance information. Exemplarily, the assistance information is used for assisting network energy saving and/or scheduling/resource allocation.

In some embodiments, before step 620, the network requests the terminal to report the assistance information, or the network indicates for the terminal to report the assistance information.

In step 640, the network performs the associated operations by using the assistance information (optional).

Exemplarily, network energy saving and/or scheduling/resource allocation is implemented based on the assistance information.

In some embodiments, implementing network energy saving includes: achieving the purpose of network energy saving, selecting or indicating network energy saving technologies, or selecting or indicating network energy saving configurations.

In some embodiments based on FIG. 5 and/or FIG. 6, the assistance information being used for assisting network energy saving includes the following: the assistance information is configured for network energy saving, or the assistance information is configured to perform network energy saving, or the assistance information is configured to acquire traffic or traffic-related information, or the assistance information is configured to ensure traffic transmission performance under the condition of ensuring network energy saving, or the assistance information is configured to achieve network energy saving and maintain network performance, or the assistance information is configured to select or configure network energy saving parameters or technologies.

In some embodiments based on FIG. 5 and/or FIG. 6, the assistance information is carried in at least one of an RRC message, a control element (CE) of medium access control (MAC), or uplink control information (UCI). In some embodiments, the RRC message is an uplink (UL) RRC message. In some embodiments, the UL RRC message is a dedicated RRC message or a terminal assistance information message (e.g., UE assistance information message).

In some embodiments based on FIG. 5 and/or FIG. 6, in the case that a first condition is satisfied, the terminal reports the assistance information to the network. The first condition includes at least one of the following:
indication for the terminal to report assistance information;
a property change of the terminal, the property including at least one of a traffic property, whether a traffic is activated, and whether a traffic is in use;
a preference change of the terminal, the preference including at least one of a preferred transmission mode, a preferred network configuration parameter, recommended information, whether energy saving is required, whether an energy saving requirement is prioritized, and whether a performance requirement is prioritized;
the terminal having not sent the assistance information since the terminal is configured to report the assistance information; or
a current value different from a value indicated in the last transmission of the assistance information.

In some embodiments based on FIG. 5 and/or FIG. 6, the network includes a base station and/or a cell.

The base station includes at least one of: a base station corresponding to a serving cell of the terminal, a base station corresponding to a primary cell of the terminal, a base station corresponding to a primary secondary cell of the terminal, a neighbor base station of the base station corresponding to the serving cell of the terminal, a neighbor base station of the base station corresponding to the primary cell of the terminal, a neighbor base station of the base station corresponding to the primary secondary cell of the terminal, or a base station in an ANR list.

The cell includes at least one of: a serving cell of the terminal, a primary cell of the terminal, a primary secondary cell of the terminal, a neighbor cell of the terminal, a cell of a neighbor base station of the base station, or a cell of the base station in the ANR list.

In some embodiments based on FIG. 5 and/or FIG. 6, the assistance information includes at least one of the following:

### Traffic Information

E.g., traffic characteristics. Exemplarily, the traffic characteristics include at least one of: period, arrival time, data size, delay tolerance value or tolerance, traffic priority, or the like.

In some embodiments, the traffic characteristics are associated with QoS flows. For example, the traffic characteristics include a QoS-flow identification.

For example, in the case that the traffic characteristics are reported, at least one of the following information is reported: traffic periodicity, message size, timing offset, or QoS-flow identification.

In some embodiments, a UE NAS or an application layer informs a UE AS of the traffic characteristics (further including QoS flow information corresponding to the traffic). The traffic characteristics are of all or part of the QoS flows, for example, of QoS flows having the same traffic characteristics in the QoS flows, or of QoS flows where the traffics are one-to-one mapped to the QoS flows, or specific QoS flows, or all QoS flows. Alternatively, the UE NAS informs the AS of traffic characteristics of all or part of the QoS flows based on traffic characteristics acquired from an application and relationships between the traffics and the QoS flows, for example, traffic characteristics of QoS flows having the same traffic characteristics in the QoS flows, or of QoS flows where the traffics are one-to-one mapped to the QoS flows, or specific QoS flows, or all QoS flows. The UE AS informs the base station of the traffic characteristics (further including the QoS-flow identification or information).

In some other embodiments, a core network informs the base station of the traffic characteristics. The traffic characteristics are associated with corresponding QoS-flow identities and/or QoS parameters. The traffic characteristics are indicated to the base station together with the QoS parameters of the QoS flows. The traffic characteristics are directly provided by the core network, or requested by the base station to the core network.

In some embodiments, for the base station, gNB makes an excellent energy saving and/or scheduling decision based on the traffic characteristics associated with one QoS flow and/or the QoS parameter of the QoS flow.

In some embodiments, the traffic characteristics or the variations thereof are recommended traffic modes, prioritized or preferred DTX/DRX configurations, or recommendations for cell on or off.

In some embodiments, an associated information configuration mode or information element (IE) is designed as follows (value ranges and the like are only examples, which are not limited in the present disclosure):

| | |
|---|---|
| TrafficPatternInfo ::= | SEQUENCE { |
| trafficPeriodicity | ENUMERATED {ms20, ms50, ms100, |

ms200, ms300, ms400, ms500, ms600, ms700, ms800, ms900, ms1000},

| | |
|---|---|
| timingOffset | INTEGER (0..10239), |
| messageSize | BIT STRING (SIZE (8)), |
| QoS-FlowIdentity-r16 | QoS-FlowIdentity-r16 |

}

In some embodiments, recommended DTX configurations include at least one of a cycle (a long cycle and/or a short cycle), a timing offset, a duration corresponding to inactive time, or the number of short cycles.

In some embodiments, an associated information configuration mode or IE is designed as follows (value ranges and the like are only examples, which are not limited in the present disclosure):

| | |
|---|---|
| DTX-Preference ::= | SEQUENCE { |
| preferredDTX-InactivityTimer | ENUMERATED { |

```
      ms0, ms1, ms2, ms3, ms4, ms5, ms6, ms8, ms10, ms20, ms30,
ms40, ms50, ms60, ms80,
      ms100, ms200, ms300, ms500, ms750, ms1280, ms 1920, ms2560,
spare9, spare8,
      spare7, spare6, spare5, spare4, spare3, spare2, spare1}
OPTIONAL,
```

| | |
|---|---|
| preferredDTX-LongCycle | ENUMERATED { |

```
      ms10, ms20, ms32, ms40, ms60, ms64, ms70, ms80, ms128,
ms160, ms256, ms320, ms512,
      ms640, ms1024, ms1280, ms2048, ms2560, ms5120, ms10240,
spare 12, spare11, spare 10,
      spare9, spare8, spare7, spare6, spare5, spare4, spare3, spare2,
spare1 } OPTIONAL,
```

| | |
|---|---|
| preferredDTX-ShortCycle | ENUMERATED { |

```
      ms2, ms3, ms4, ms5, ms6, ms7, ms8, ms10, ms14, ms16, ms20,
ms30, ms32,
      ms35, ms40, ms64, ms80, ms128, ms160, ms256, ms320, ms512,
ms640, spare9,
      spare8, spare7, spare6, spare5, spare4, spare3, spare2, spare1 }
OPTIONAL,
```

| | |
|---|---|
| preferredDTX-ShortCycleTimer | INTEGER (1..16) |
| | OPTIONAL |

}

### Recommended Network on Information;

Exemplarily, the recommended network on information includes at least one of the following: a cell identification, a base station identification, a request to turn on the network, or time about the network being on. The time about the network being on includes at least one of the following: a pattern, a duration of the network being on, a start time of the network being on, an end time of the network being on, a period of the network being on, or a sequence of turning on and turning off the network. The pattern includes at least one of: a network on-off pattern or network off-on pattern, a time period of network being on or time distribution of network being on in a pattern, or a period of a pattern.

For example, the UE is a connected state UE, or a UE supporting energy saving, or a UE having the reporting capability, or the aforementioned UE.

In some embodiments, the UE requests its serving cell to transition to a cell off state or use cell DTX/DRX configurations. In some embodiments, the UE requests its serving cell to transition to a cell off state or use cell DTX/DRX configurations based on traffic characteristics, or in the case that a traffic transmission requirement is determined, or in the case that it is determined that the traffic transmission requirement is discontinuous.

### Recommended Network Off Information;

Exemplarily, the recommended network off information includes at least one of the following: a cell identification, a base station identification, a request to turn off the network, or time about the network being off. The time about the network being off include at least one of the following: a pattern, a duration of the network being off, a start time of the network being off, an end time of the network being off, a period of the network being off, or a sequence of turning on and turning off the network. The pattern includes at least one of: a network on-off pattern or network off-on pattern, a time period of network being off or time distribution of network being off in a pattern, or a period of a pattern.

For example, the UE is a connected state UE, or a UE supporting energy saving, or a UE having the reporting capability, or the aforementioned UE.

In some embodiments, the UE requests its serving cell to transition to a cell off state or use cell DTX/DRX configurations. In some embodiments, the UE requests its serving cell to transition to a cell off state or use cell DTX/DRX configurations based on traffic characteristics, or in the case that a traffic transmission requirement is determined, or in the case that it is determined that the traffic transmission requirement is discontinuous, or in the case of no traffic transmission requirement in a period of time.

### Recommended Network DTX Information;

Exemplarily, the recommended network DTX information includes at least one of the following: a cell identification, a base station identification, a network DTX indication, or network DTX configurations.

The network DTX configurations include at least one of: a DTX cycle, a DTX pattern, DTX on information, DTX off information, a DTX on duration, a DTX off duration, a sequence of turning on and turning off DTX in one DTX cycle, a sequence of turning on and turning off DTX in one DTX pattern, a DTX start offset (a DTX start time point), a DTX on start time, or a DTX off start time.

In some embodiments, the DTX configuration or DTX pattern includes at least one cycle, e.g., a long cycle and/or a short cycle.

In some embodiments, the DTX configuration or DTX pattern includes a DTX on/DTX off configuration, e.g., a long DTX on configuration/short DTX off configuration, different DTX on start times/DTX off start times, and different DTX on/DTX off durations.

In some embodiments, in the DTX cycle or DTX pattern, the DTX on occurs first and then the DTX off.

In some embodiments, the recommended cell DTX configuration includes at least one of a cell identification, a cycle (a long cycle and/or short cycle), a timing offset, a duration corresponding to an inactive state, the number of short cycles, a duration or a time period of DTX configuration use.

In some embodiments, an associated information configuration mode or information IE is designed as follows (value ranges and the like are only examples, which are not limited in the present disclosure):

| | |
|---|---|
| DTX-Preference ::= | SEQUENCE { |
| preferredDTX-InactivityTimer | ENUMERATED { |

```
    ms0, ms1, ms2, ms3, ms4, ms5, ms6, ms8, ms10, ms20, ms30,
ms40, ms50, ms60, ms80,
    ms100, ms200, ms300, ms500, ms750, ms1280, ms 1920, ms2560,
spare9, spare8,
    spare7, spare6, spare5, spare4, spare3, spare2, spare1}
OPTIONAL,
```

| | |
|---|---|
| preferredDTX-LongCycle | ENUMERATED { |

```
    ms10, ms20, ms32, ms40, ms60, ms64, ms70, ms80, ms128,
ms160, ms256, ms320, ms512,
    ms640, ms1024, ms1280, ms2048, ms2560, ms5120, ms10240,
spare12, spare11, spare10,
    spare9, spare8, spare7, spare6, spare5, spare4, spare3, spare2,
spare1 } OPTIONAL,
```

| | |
|---|---|
| preferredDTX-ShortCycle | ENUMERATED { |

```
    ms2, ms3, ms4, ms5, ms6, ms7, ms8, ms10, ms14, ms16, ms20,
ms30, ms32,
    ms35, ms40, ms64, ms80, ms128, ms160, ms256, ms320, ms512,
ms640, spare9,
    spare8, spare7, spare6, spare5, spare4, spare3, spare2, spare1 }
OPTIONAL,
```

| | |
|---|---|
| preferredDTX-ShortCycleTimer | INTEGER (1..16) |
| | OPTIONAL |

}

### Recommended Network DRX Information;

Exemplarily, the recommended network DRX information includes at least one of the following: a cell identification, a base station identification, a network DRX indication, or network DRX configurations.

The network DRX configurations include at least one of: a DRX cycle, a DRX pattern, DRX on information, DRX off information, a DRX on duration, a DRX off duration, a sequence of turning on and turning off DRX in one DRX cycle, a sequence of turning on and turning off DRX in one DRX pattern, a DRX start offset (a DRX start time point), a DRX on start time, and a DRX off start time.

In some embodiments, the DRX configuration or DRX pattern includes at least one cycle, e.g., a long cycle and/or a short cycle.

In some embodiments, the DRX configuration or DRX pattern includes a DRX on/DRX off configuration, e.g., a long DRX on configuration/short DRX off configuration, different DRX on start times/DRX off start times, and different DRX on/DRX off durations.

In some embodiments, in the DRX cycle or DRX pattern, the DRX on occurs first and then the DRX off.

In some embodiments, the recommended cell DRX configuration includes at least one of a cell identification, a cycle (a long cycle and/or short cycle), a timing offset, a duration corresponding to an inactive state, the number of short cycles, a duration or a time period of DRX configuration use.

In some embodiments, an associated information configuration mode or information IE is designed as follows (value ranges and the like are only examples, which are not limited in the present disclosure):

| | |
|---|---|
| DRX-Preference ::= | SEQUENCE { |
| preferredDRX-InactivityTimer | ENUMERATED { |

```
    ms0, ms1, ms2, ms3, ms4, ms5, ms6, ms8, ms10, ms20, ms30,
ms40, ms50, ms60, ms80,
    ms100, ms200, ms300, ms500, ms750, ms1280, ms 1920, ms2560,
spare9, spare8,
    spare7, spare6, spare5, spare4, spare3, spare2, spare1}
OPTIONAL,
```

| | |
|---|---|
| preferredDRX-LongCycle | ENUMERATED { |

```
    ms10, ms20, ms32, ms40, ms60, ms64, ms70, ms80, ms128,
ms160, ms256, ms320, ms512,
    ms640, ms1024, ms1280, ms2048, ms2560, ms5120, ms10240,
spare12, spare11, spare 10,
    spare9, spare8, spare7, spare6, spare5, spare4, spare3, spare2,
spare1 } OPTIONAL,
```

| | |
|---|---|
| preferredDRX-ShortCycle | ENUMERATED { |

```
    ms2, ms3, ms4, ms5, ms6, ms7, ms8, ms10, ms14, ms16, ms20,
ms30, ms32,
    ms35, ms40, ms64, ms80, ms128, ms160, ms256, ms320, ms512,
ms640, spare9,
    spare8, spare7, spare6, spare5, spare4, spare3, spare2, spare1 }
OPTIONAL,
```

| | |
|---|---|
| preferredDRX-ShortCycleTimer | INTEGER (1..16) |
| | OPTIONAL |

}

### Recommended Terminal DTX Information;

Exemplarily, the recommended terminal DTX information includes at least one of the following: a UE identification, a terminal DTX request, a terminal DTX indication, or a terminal DTX configuration recommendation.

The terminal DTX configuration recommendation includes at least one of: a DTX cycle, a DTX pattern, DTX on information, DTX off information, a DTX on duration, a DTX off duration, a sequence of turning on and turning off DTX in a DTX cycle, a sequence of turning on and turning off DTX in a DTX pattern, a DTX start offset (a DTX start time point), a DTX on start time, and a DTX off start time.

In some embodiments, the DTX configuration or DTX pattern includes at least one cycle, e.g., a long cycle and/or a short cycle.

In some embodiments, the DTX configuration or DTX pattern includes a DTX on/DTX off configuration, e.g., a long DTX on configuration/short DTX off configuration, different DTX on start times/DTX off start times, and different DTX on/DTX off durations.

In some embodiments, in the DTX cycle or DTX pattern, the DTX on occurs first and then the DTX off.

In some embodiments, recommended DTX configurations include at least one of a cycle (a long cycle and/or a short cycle), a timing offset, a duration corresponding to inactive time, or the number of short cycles.

In some embodiments, an associated information configuration mode or information IE is designed as follows (value ranges and the like are only examples, which are not limited in the present disclosure):

| | |
|---|---|
| DTX-Preference ::= | SEQUENCE { |
| preferredDTX-InactivityTimer | ENUMERATED { |

```
    ms0, ms1, ms2, ms3, ms4, ms5, ms6, ms8, ms10, ms20, ms30,
ms40, ms50, ms60, ms80,
    ms100, ms200, ms300, ms500, ms750, ms1280, ms1920, ms2560,
spare9, spare8,
    spare7, spare6, spare5, spare4, spare3, spare2, spare1}
OPTIONAL,
```

| | |
|---|---|
| preferredDTX-LongCycle | ENUMERATED { |

```
    ms10, ms20, ms32, ms40, ms60, ms64, ms70, ms80, ms128,
ms160, ms256, ms320, ms512,
    ms640, ms1024, ms1280, ms2048, ms2560, ms5120, ms10240,
spare12, spare11, spare 10,
    spare9, spare8, spare7, spare6, spare5, spare4, spare3, spare2,
spare1 } OPTIONAL,
```

| | |
|---|---|
| preferredDTX-ShortCycle | ENUMERATED { |

```
    ms2, ms3, ms4, ms5, ms6, ms7, ms8, ms10, ms14, ms16, ms20,
ms30, ms32,
    ms35, ms40, ms64, ms80, ms128, ms160, ms256, ms320, ms512,
ms640, spare9,
    spare8, spare7, spare6, spare5, spare4, spare3, spare2, spare1 }
OPTIONAL,
```

| | |
|---|---|
| preferredDTX-ShortCycleTimer | INTEGER (1..16) |
| | OPTIONAL |

}

### Recommended Terminal DRX Information;

Exemplarily, the recommended terminal DRX information includes at least one of the following: a UE identification, a terminal DRX request, a terminal DRX indication, or a terminal DRX configuration recommendation.

The terminal DRX configuration recommendation includes at least one of: a DRX cycle, a DRX pattern, DRX on information, DRX off information, a DRX on duration, a DRX off duration, a sequence of turning on and turning off DRX in one DRX cycle, a sequence of turning on and turning off DRX in one DRX pattern, a DRX start offset (a DRX start time point), a DRX on start time, and a DRX off start time.

In some embodiments, the DRX configuration or DRX pattern includes at least one cycle, e.g., a long cycle and/or a short cycle.

In some embodiments, the DRX configuration or DRX pattern includes a DRX on/DRX off configuration, e.g., a long DRX on configuration/short DRX off configuration, different DRX on start times/DRX off start times, and different DRX on/DRX off durations.

In some embodiments, in the DRX cycle or DRX pattern, the DRX on occurs first and then the DRX off.

In some embodiments, recommended DRX configurations include at least one of a cycle (a long cycle and/or a short cycle), a timing offset, a duration corresponding to an inactive state, or the number of short cycles.

In some embodiments, an associated information configuration mode or information IE is designed as follows (value ranges and the like are only examples, which are not limited in the present disclosure):

| | |
|---|---|
| DRX-Preference ::= | SEQUENCE { |
| preferredDRX-InactivityTimer | ENUMERATED { |

```
    ms0, ms1, ms2, ms3, ms4, ms5, ms6, ms8, ms10, ms20, ms30,
ms40, ms50, ms60, ms80,
    ms100, ms200, ms300, ms500, ms750, ms1280, ms1920, ms2560,
spare9, spare8,
    spare7, spare6, spare5, spare4, spare3, spare2, spare1}
OPTIONAL,
```

| | |
|---|---|
| preferredDRX-LongCycle | ENUMERATED { |

```
    ms10, ms20, ms32, ms40, ms60, ms64, ms70, ms80, ms128,
ms160, ms256, ms320, ms512,
    ms640, ms1024, ms1280, ms2048, ms2560, ms5120, ms10240,
spare12, spare11, spare 10,
    spare9, spare8, spare7, spare6, spare5, spare4, spare3, spare2,
spare1 } OPTIONAL,
```

| | |
|---|---|
| preferredDRX-ShortCycle | ENUMERATED { |

```
    ms2, ms3, ms4, ms5, ms6, ms7, ms8, ms10, ms14, ms16, ms20,
ms30, ms32,
    ms35, ms40, ms64, ms80, ms128, ms160, ms256, ms320, ms512,
ms640, spare9,
    spare8, spare7, spare6, spare5, spare4, spare3, spare2, spare1 }
OPTIONAL,
```

| | |
|---|---|
| preferredDRX-ShortCycleTimer | INTEGER (1..16) |
| | OPTIONAL |

}

### Information Indicating or Requesting the Network to Transition a Cell State;

Exemplarily, the information indicating or requesting the network to transition the cell state includes at least one of the following: a cell identification, a base station identification, a cell state transition indication, a cell state to transition from or transition to, or a duration of cell state transition.

The duration of cell state transition includes at least one of: a start time of cell state transition, a duration of cell state transition, or an end time of cell state transition.

### Information Indicating or Requesting the Network to Perform Network State Transition;

Exemplarily, the information indicating or requesting the network to perform network state transition includes at least one of the following: a cell identification, a base station identification, a network state transition indication, a network state to transition from or transition to, or a duration of network state transition.

The duration of network state transition includes at least one of: a start time of network state transition, a duration of network state transition, or an end time of network state transition.

### Information Indicating or Requesting the Network to Enter a DTX State;

Exemplarily, the information indicating or requesting the network to enter a DTX state includes at least one of the following: a cell identification, a base station identification, a DTX state indication, a DTX state request, or a duration of DTX state.

The duration of DTX state includes at least one of: a start time of DTX state, a duration of DTX state, or an end time of DTX state.

### Information Indicating or Requesting the Network to Enter a DRX State;

Exemplarily, the information indicating or requesting the network to enter a DRX state includes at least one of the following: a cell identification, a base station identification, a DRX state indication, a DRX state request, or a duration of DRX state.

The duration of DRX state includes at least one of: a start time of DRX state, a duration of DRX state, or an end time of DRX state.

### A Requested Pattern of a Network State;

Exemplarily, the network states include at least one of the following: network on, network off, network sleep, network non-sleep, network normal transmission, a network DRX state, a network DTX state, or at least two levels of load states.

The pattern of the network state may be of two or more types, e.g., network on/network off, network on/network off/DRX/DTX, and low load/medium load/high load states.

In some embodiments, the pattern of the network state reporting further includes a cell identification and/or a base station identification.

### A Recommended Transmission Configuration of a Reference Signal;

Exemplarily, the transmission configuration of the reference signal includes at least one of the following: sequence information, port information, frequency domain resources, time domain resources, code domain resources, spatial information, or power information.

In some embodiments, the reporting further includes a cell identification and/or a base station identification.

### A Recommended Transmission Interval of a Reference Signal;

Exemplarily, the transmission interval of the reference signal includes a slot interval.

In some embodiments, the reporting further includes related reference information types, e.g., SRS, CSI-RS, and PRS.

In some embodiments, the reporting further includes a cell identification and/or a base station identification.

### Recommended Transmission Pattern of a Reference Signal;

Exemplarily, the transmission pattern of the reference signal includes at least one of the following: DTX, DRX, a periodic pattern, a semi-persistent pattern, or an aperiodic pattern.

In some embodiments, the reporting further includes related reference information types, e.g., SRS, CSI-RS, and PRS.

In some embodiments, the reporting further includes a cell identification and/or a base station identification.

### A Recommended Transmission Configuration of Data;

Exemplarily, the transmission configuration of data includes at least one of the following: sequence information, port information, frequency domain resources, time domain resources, code domain resources, spatial information, or power information.

In some embodiments, the reporting further includes related data types, e.g., configured grant, SPS, dynamic grant (DG), PUSCH, and PDSCH.

In some embodiments, the reporting further includes a cell identification and/or a base station identification.

### A Recommended Transmission Interval of Data;

Exemplarily, the transmission interval of data includes a slot interval.

In some embodiments, the reporting further includes related data types, e.g., configured grant, SPS, DG, PUSCH, and PDSCH.

In some embodiments, the reporting further includes a cell identification and/or a base station identification.

### A Recommended Transmission Pattern of Data;

Exemplarily, the transmission pattern of data includes at least one of the following: DTX, DRX, a periodic pattern, a semi-persistent pattern, or an aperiodic pattern.

In some embodiments, the reporting further includes related data types, e.g., configured grant, SPS, DG, PUSCH, and PDSCH.

In some embodiments, the reporting further includes a cell identification and/or a base station identification.

### A Recommended Transmission Configuration of System Information;

Exemplarily, the transmission configuration of system information includes at least one of the following: sequence information, port information, frequency domain resources, time domain resources, code domain resources, spatial information, or power information.

In some embodiments, the reporting further includes related system information types, e.g., master indication block (MIB), SIB1, SIB2, on-demand SIB, and other SIBs.

In some embodiments, the reporting further includes a cell identification and/or a base station identification.

### A Recommended Transmission Interval of System Information;

Exemplarily, the transmission interval of system information includes a slot interval.

In some embodiments, the reporting further includes related system information types, e.g., MIB, SIB1, SIB2, on-demand SIB, and other SIBs.

In some embodiments, the reporting further includes a cell identification and/or a base station identification.

### A Recommended Transmission Pattern of System Information;

Exemplarily, the transmission pattern of system information includes at least one of the following: DTX, DRX, a periodic pattern, a semi-persistent pattern, or an aperiodic pattern.

In some embodiments, the reporting further includes related system information types, e.g., MIB, SIB1, SIB2, on-demand SIB, and other SIBs.

In some embodiments, the reporting further includes a cell identification and/or a base station identification.

### A Preferred Transmission Mode;

Exemplarily, the preferred transmission mode includes at least one of the following: whether to transmit, how to transmit, or which pieces of information to transmit.

In some embodiments, the reporting further includes types corresponding to the related preferred transmission mode, e.g., data, channels, reference signals, and system information.

In some embodiments, the reporting further includes a cell identification and/or a base station identification.

### A Preferred Network Configuration Parameter.

Exemplarily, the network configuration parameter includes at least one of configuration parameters in RRC dedicated signaling and/or common signaling.

Exemplarily, the network configuration parameter includes at least one of the following: a configured grant (CG) configuration parameter, an SPS configuration parameter, a physical uplink control channel (PUCCH) configuration parameter, a PUSCH configuration parameter, a synchronization signal block (SSB) configuration parameter, an MIB configuration parameter, an SIB configuration parameter, a PDSCH configuration parameter, a scheduling request (SR) configuration parameter, a PRACH configuration parameter, a DRX configuration parameter, a search space configuration parameter, a DTX configuration parameter, an RACH configuration parameter, a PDCCH configuration parameter, a reference signal configuration parameter, or a DG configuration parameter.

In some embodiments, the reporting further includes a cell identification and/or a base station identification.

In summary, based on the methods according to the embodiments of FIG. 5 and/or FIG. 6, the transmission performance requirement is ensured while ensuring the goal of the network energy saving by reporting the assistance information.

FIG. 7 illustrates a schematic flowchart of a method for saving energy according to some embodiments of the present disclosure. For example, the method is applicable to a terminal, and therefore the method includes at least part of the following steps:

In step 720, network states or network configurations are acquired.

The network states include a base station state or a cell state.

The base station state includes at least one of: a state of the base station corresponding to the serving cell of the terminal, a state of the base station corresponding to the primary cell of the terminal, a state of the base station corresponding to the primary secondary cell of the terminal, a state of the neighbor base station of the base station corresponding to the serving cell of the terminal, a state of the neighbor base station of the base station corresponding to the primary cell of the terminal, a state of the neighbor base station of the base station corresponding to the primary secondary cell of the terminal, or a state of the base station in the ANR list.

The cell state includes at least one of: a state of the serving cell of the terminal, a state of the primary cell of the terminal, a state of the primary secondary cell of the terminal, a state of the neighbor cell of the terminal, a state of the cell of the neighbor base station of the base station, or a state of the cell of the base station in the ANR list.

In some embodiments, the network states include at least one of the following: a cell network on indication, a cell network off indication, a base station network on indication, a base station network off indication, a cell identification, a base station identification, a cell DTX indication, a base station DTX indication, a cell DRX indication, a base station DRX indication, base station network on information, base station network off information (as in the corresponding embodiments of FIG. 5 or FIG. 6), cell network on information, cell network off information, a base station DRX configuration, a base station DTX configuration, a cell DRX configuration, a cell DTX configuration (as in the corresponding embodiments of FIG. 5 or FIG. 6), a cell network sleep, a cell network non-sleep, a base station network sleep, a base station network non-sleep, a cell network normal transmission, a base station network normal transmission, a cell network DRX state, a base station network DRX state, a cell network DTX state, a base station network DTX state, a first level load state of at least two levels of load states, a second level load state of at least two levels of load states, or a third level load state of at least two levels of load states.

In some embodiments, the network state is an implicit network state, that is, the network indicates a network energy saving technology or a network energy saving configuration used, and the network energy saving technology or the network energy saving configuration corresponds to the corresponding network state. For example, the network indicates an extended parameter configuration, corresponding to the DTX state, the DRX state, or the medium load state; or, the network indicates data and/or signaling and/or system information transmission based on the first configuration, corresponding to the DTX state, the DRX state, or the medium load state; or, the network indicates no transmission of data and/or signaling and/or system information, corresponding to the network off state.

In some embodiments, the network state is an implicit network state, that is, the network indicates information transmitted/sent/received. The information includes data and/or signaling and/or system information.

In some embodiments, the network state is an implicit network state, i.e., an updated RRC configuration message, or the network updates the RRC configuration. Exemplarily, the network configuration includes at least one of configuration parameters in RRC dedicated signaling and/or common signaling.

Exemplarily, the network configuration is an RRC message carrying at least one of the following configurations: a CG configuration, an SPS configuration, a PUSCH configuration, a PDSCH configuration, an SR configuration, a PRACH configuration, a RACH configuration, a PUCCH configuration, a PDCCH configuration, an SIB configuration, a master indication block (MIB) configuration, a reference signal configuration, a search space configuration, a DRX configuration, a DTX configuration, a DG configuration, an SSB configuration, or the like.

In step 740, based on network configurations or network states or network state changes, data transmission and/or signaling transmission and/or system information transmission is performed.

In some embodiments, the data transmission and/or signaling transmission and/or system information transmission is performed based on network configurations, and at least one of the network configurations is associated with network energy saving.

In some embodiments, the data transmission and/or signaling transmission and/or system information transmission is performed based on network states, and at least one of the network states is associated with network energy saving.

In some embodiments, the data transmission and/or signaling transmission and/or system information transmission is performed based on network state changes, and at least one of the changed network states is associated with network energy saving.

In some embodiments, the network states are of two or more types, e.g., network on/network off, network on/network off/DRX/DTX, and low load/medium load/high load states.

In some embodiments, the terminal, in the case of network indications or enablement, performs the data transmission and/or signaling transmission and/or system information transmission, and at least one piece of information of the network indications or enablement is associated with network energy saving.

In some embodiments, the pattern of the data transmission and/or signaling transmission and/or system information transmission is determined based on indications or information for network state change.

In some embodiments, performing data transmission and/or signaling transmission and/or system information transmission based on network states includes at least one of the following:
performing the data transmission and/or signaling transmission and/or system information transmission based on the network states in the case that the network indicates the terminal; or
performing the data transmission and/or signaling transmission and/or system information transmission based on the network states in the case that the terminal reports the assistance information.

In some embodiments, in the case that the network indicates network states or state changes to the terminal, the data transmission and/or signaling transmission and/or system information transmission is performed based on the network state or the network state change indication.

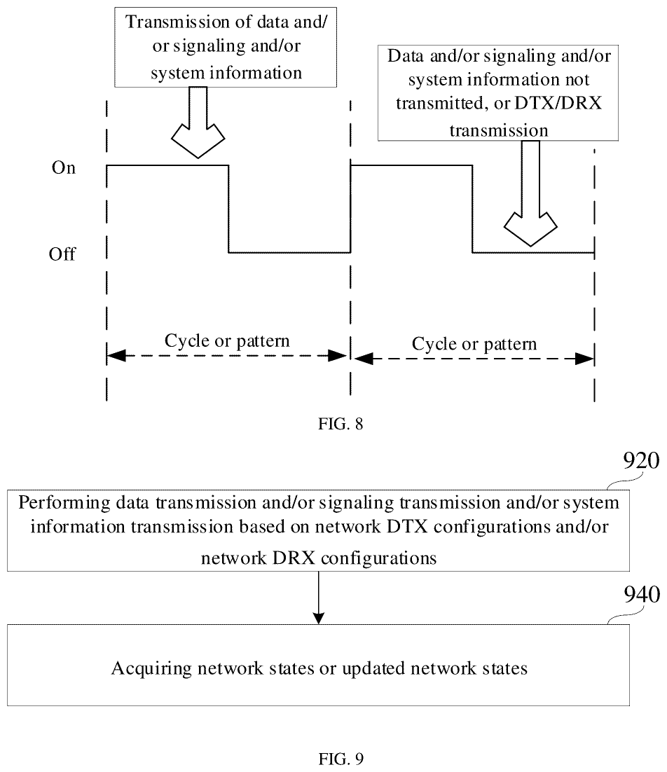

In some embodiments, performing data transmission and/or signaling transmission and/or system information transmission based on network states includes at least one of the following:
not performing the data transmission and/or signaling transmission and/or system information transmission in the case that the network is off;
performing the data transmission and/or signaling transmission and/or system information transmission based on a first configuration in the case that the network is off;
performing the data transmission and/or signaling transmission and/or system information transmission based on the DTX/DRX configuration of the network in the case that the network is off;
performing the data transmission and/or signaling transmission and/or system information transmission in the case that the network is on;
performing the data transmission and/or signaling transmission and/or system information transmission based on a default configuration in the case that the network is on;
performing the data transmission and/or signaling transmission and/or system information transmission in the case that network DTX is on (as shown in FIG. 8);
not performing the data transmission and/or signaling transmission and/or system information transmission in the case that the network DTX is off (as shown in FIG. 8);
performing the data transmission and/or signaling transmission and/or system information transmission based on the first configuration in the case that the network DTX is off;
performing the data transmission and/or signaling transmission and/or system information transmission based on the first configuration in the case of the network DTX,
which is understood as follows: performing data transmission and/or signaling transmission and/or system information transmission in a DTX on state, or enlarging the interval of the data transmission and/or signaling transmission and/or system information transmission, that is, “performing data transmission at cell DTX on state or enlarge the data transmission interval”;
performing the data transmission and/or signaling transmission and/or system information transmission in the case that network DRX is on (as shown in FIG. 8);
not performing data transmission and/or signaling transmission and/or system information transmission in the case that the network DRX is off (as shown in FIG. 8);
performing the data transmission and/or signaling transmission and/or system information transmission based on the first configuration in the case that the network DRX is off; or
performing the data transmission and/or signaling transmission and/or system information transmission based on the first configuration in the case of the network DRX.

The first configuration is associated with network energy saving or provided with an enlarged interval as compared with the default configuration.

It is understood as follows: performing data transmission and/or signaling transmission and/or system information transmission in a DRX on state, or enlarging the interval of the data transmission and/or signaling transmission and/or system information transmission, that is, “performing data transmission at cell DRX on state or enlarge the data transmission interval”.

If a cell off mechanism is enabled, we understand that there should be no data transmission during the cell off situation. From the UE perspective, the UE stops data transmission when it knows the cell off information or receives the data transmission disabling indication. If a mechanism of the reduced/adapted transmission/reception occasion is enabled, we understand that discontinuous transmission is allowed. For example, the UE transmits data with a certain duration, e.g., performing data transmission in a DTX/DRX pattern or using an enlarged transmission interval of data when the UE receives a cell DRX/DTX configuration or an enlarged signaling configuration.

The UE should be informed with such configuration or the cell on/off situation to align with the network intention. Such configuration or the cell on/off situation is transmitted over dynamic signaling (e.g., RRC/DCI signaling) or a semi-static configuration (e.g., a configured pattern). Accordingly, the UE operates the data transmission based on this kind of network information.

That is, “If the mechanism of cell off is enabled, we understand there should be no data transmitted during the cell off situation. From the UE perspective, the UE can stop data transmission when it knows the cell off information or receives the data transmission disabling indication. If the mechanism of the reduced/adapted transmission/reception occasion is enabled, we understand that a discontinuous transmission is allowed. For example, the UE can transmit data using a certain duration, e.g. performing data transmission in DTX/DRX mode or using an enlarged data transmission interval when the UE receiving a cell DRX/DTX configuration or an enlarged signaling configuration.

the UE should be informed with such configuration or the cell on/off situation to align with the network intention. Such configuration or the cell on/off situation can be sent via dynamic signaling (e.g. RRC/DCI signaling) or a semi-static configuration (e.g. a configured pattern). Accordingly, the UE can rely on this kind of network information to operate the data transmission.”

In step 760, updated network states or updated network configurations are acquired.

The updated network states include an updated base station state or an updated cell state.

The updated base station state includes at least one of: an updated state of the base station corresponding to the serving cell of the terminal, an updated state of the base station corresponding to the primary cell of the terminal, an updated state of the base station corresponding to the primary secondary cell of the terminal, an updated state of the neighbor base station of the base station corresponding to the serving cell of the terminal, an updated state of the neighbor base station of the base station corresponding to the primary cell of the terminal, an updated state of the neighbor base station of the base station corresponding to the primary secondary cell of the terminal, or an updated state of the base station in the ANR list.

The updated cell state includes at least one of: an updated state of the serving cell of the terminal, an updated state of the primary cell of the terminal, an updated state of the primary secondary cell of the terminal, an updated state of the neighbor cell of the terminal, an updated state of the cell of the neighbor base station of the base station, or an updated state of the cell of the base station in the ANR list.

In some embodiments, the updated network states include at least one of the following: a cell network on indication, a cell network off indication, a base station network on indication, a base station network off indication, a cell identification, a base station identification, a cell DTX indication, a base station DTX indication, a cell DRX indication, a base station DRX indication, base station network on information, base station network off information (as in the corresponding embodiments of FIG. 5 or FIG. 6), cell network on information, cell network off information, a base station DRX configuration, a base station DTX configuration, a cell DRX configuration, a cell DTX configuration (as in the corresponding embodiments of FIG. 5 or FIG. 6), a cell network sleep, a cell network non-sleep, a base station network sleep, a base station network non-sleep, a cell network normal transmission, a base station network normal transmission, a cell network DRX state, a base station network DRX state, a cell network DTX state, a base station network DTX state, a first level load state of at least two levels of load states, a second level load state of at least two levels of load states, or a third level load state of at least two levels of load states.

In some embodiments, the updated network state is an implicit network state, that is, the network indicates a network energy saving technology or a network energy saving configuration used, and the network energy saving technology or the network energy saving configuration corresponds to the corresponding updated network state. For example, the network indicates an extended parameter configuration, corresponding to the DTX state, the DRX state, or the medium load state; or, the network indicates data and/or signaling and/or system information transmission based on the first configuration, corresponding to the DTX state, the DRX state, or the medium load state; or, the network indicates no transmission of data and/or signaling and/or system information, corresponding to the network off state.

In some embodiments, the updated network state is an implicit network state, that is, the network indicates information transmitted/sent/received. The information includes data and/or signaling and/or system information.

In some embodiments, the network state is an implicit network state, i.e., an updated RRC configuration message, or the network updates the RRC configuration.

Exemplarily, the network configuration parameter includes at least one of configuration parameters in RRC dedicated signaling and/or common signaling.

Exemplarily, the network configuration is an RRC message carrying at least one of the following configurations, e.g., a CG configuration, an SPS configuration, a PUSCH configuration, a PDSCH configuration, an SR configuration, a PRACH configuration, a RACH configuration, a PUCCH configuration, a PDCCH configuration, a SIB configuration, a master indication block (MIB) configuration, a reference signal configuration, a search space configuration, a DRX configuration, a DTX configuration, a DG configuration, or an SSB configuration.

For example, the network configuration indicates a change of the cell situation to cell off. In the case of switching to cell off, we understand that there should be no data transmission during the cell off situation. From the UE perspective, the UE stops data transmission when it knows the cell off information or receives the data transmission disabling indication (when switch to cell off, we understand there should be no data transmitted during the cell off situation. From the UE perspective, the UE can stop data transmission when it knows the cell off information or receives the data transmission disabling indication). For example, the UE indicates an updated network configuration, e.g., an extended transmission interval or triggering DRX/DTX. In the case of switching to an extended transmission interval or triggering DRX/DTX, we understand that discontinuous transmission is allowed. For example, the UE transmits data with a certain duration, e.g., performing data transmission in DTX/DRX pattern or using an enlarged data transmission interval when the UE receives a cell DRX/DTX configuration or an enlarged signaling configuration (we understand that a discontinuous transmission is allowed. For example, the UE can transmit data using a certain duration, e.g. performing data transmission in DTX/DRX mode or using an enlarged data transmission interval when the UE receiving a cell DRX/DTX configuration or an enlarged signaling configuration).

The UE should be informed with such configuration or the cell on/off situation to align with the network intention. Such configuration or the cell on/off situation is transmitted via dynamic signaling (e.g., RRC/DCI signaling) or a semi-static configuration (e.g., a configured pattern). Accordingly, the UE relies on this kind of network information to operate the data transmission (the UE should be informed with such configuration or the cell on/off situation to align with the network intention. Such configuration or the cell on/off situation can be sent via dynamic signaling (e.g. RRC/DCI signaling) or a semi-static configuration (e.g. a configured pattern). Accordingly, the UE can rely on this kind of network information to operate the data transmission).

In some embodiments, the data and/or signaling and/or system information includes at least one of the following:
common information or signaling; or
terminal-specific information or signaling or data.

In some embodiments, the common information or signaling includes at least one of: an SSB, an MIB, a system information block SIB1, other SIBs, a common reference signal (RS), or a physical random access channel (PRACH).

The terminal-specific information or signaling or data includes at least one of: a terminal-specific reference signal, a physical downlink control channel (PDCCH), a physical uplink control channel (PUCCH), downlink data, uplink data, a DG, SPS, a CG, or an SR.

In summary, the methods according to the embodiments support performing different transmission modes based on the network state to achieve the purpose of network energy saving.

FIG. 9 illustrates a schematic flowchart of a method for saving energy according to some embodiments of the present disclosure. For example, the method is applicable to a terminal, and therefore the method includes at least part of the following steps:

In step 920, the data transmission and/or signaling transmission and/or system information transmission is performed based on network DTX configurations and/or network DRX configurations.

At least one of the network DTX configurations and/or the network DRX configurations is associated with network energy saving.

In some embodiments, performing data transmission and/or signaling transmission and/or system information transmission based on the network DTX configurations and/or the network DRX configurations includes at least one of the following:
performing the data transmission and/or signaling transmission and/or system information transmission in the case that network DTX is on;
not performing the data transmission and/or signaling transmission and/or system information transmission in the case that the network DTX is off;
performing the data transmission and/or signaling transmission and/or system information transmission based on the first configuration in the case that the network DTX is off;
performing the data transmission and/or signaling transmission and/or system information transmission based on the first configuration in the case of the network DTX,
which is understood as follows: performing data transmission and/or signaling transmission and/or system information transmission in a DTX on state, or enlarging the interval of the data transmission and/or signaling transmission and/or system information transmission, that is, “performing data transmission at cell DTX on state or enlarge the data transmission interval”;
performing the data transmission and/or signaling transmission and/or system information transmission in the case that network DRX is on;
not performing the data transmission and/or signaling transmission and/or system information transmission in the case that the network DRX is off;
performing the data transmission and/or signaling transmission and/or system information transmission based on the first configuration in the case that the network DRX is off; or
performing the data transmission and/or signaling transmission and/or system information transmission based on the first configuration in the case of the network DRX,
which is understood as follows: performing data transmission and/or signaling transmission and/or system information transmission in a DRX on state, or enlarging the interval of the data transmission and/or signaling transmission and/or system information transmission, that is, “performing data transmission at cell DRX on state or enlarge the data transmission interval”. In some embodiments, enlarging the interval of data transmission and/or signaling transmission and/or system information transmission is understood that “the interval of data transmission and/or signaling transmission and/or system information transmission in an energy saving state is larger than the interval of data transmission and/or signaling transmission and/or system information transmission in a non-energy saving state”.

The first configuration is associated with network energy saving or provided with an enlarged interval as compared with the default configuration.

In some embodiments, the data and/or signaling and/or system information is default, or network indicated, or pre-configured.

In some embodiments, performing data transmission and/or signaling transmission and/or system information transmission based on the network DTX configurations and/or the network DRX configurations is understood that default or network indicated or pre-configured data and/or signaling and/or system information is transmitted based on the network DTX configurations and/or the network DRX configurations.

In step 940, network states or updated network states are acquired.

In some embodiments, before step 920 or in step 920, the network state is acquired.

In some embodiments, after step 920, the updated network state is acquired.

In some embodiments, the network state is determined based on indications or information for network state change.

In some embodiments, the updated network state is determined based on indications or information for network state change.

In some embodiments, the network state or the updated network state is implicitly indicated based on at least one of the following information:
an energy saving technology indication;
an energy saving configuration;
an energy saving indication;
a network state transition indication;
whether a network state transition indication is received;
a network transmission configuration;
a network configuration;
indicated information that is allowed to be transmitted/sent/received;
common information or signaling; or
terminal-specific information or signaling or data.

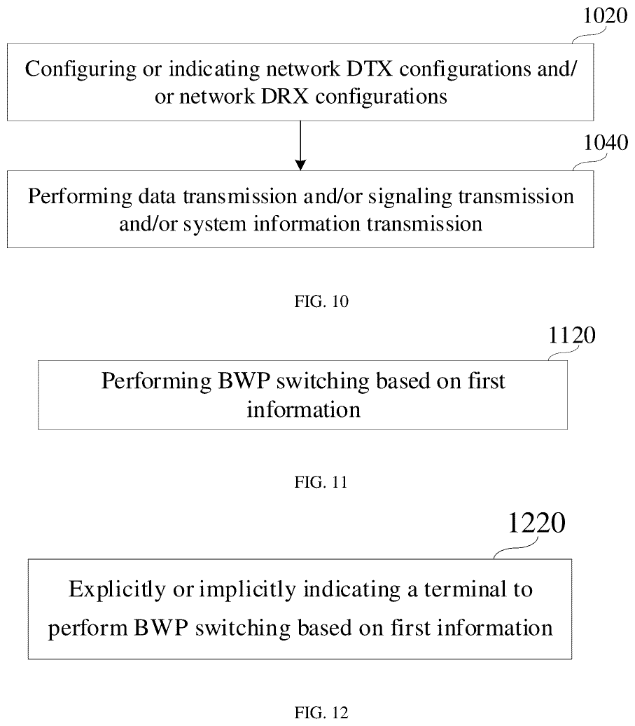

FIG. 10 illustrates a schematic flowchart of a method for saving energy according to some exemplary embodiments of the present disclosure. For example, the method is applicable to a network, and therefore the method includes at least part of the following steps.

In step 1020, network DTX configurations and/or network DRX configurations are configured or indicated.

For example, at least one of the network DTX configurations and/or the network DRX configurations is associated with network energy saving.

In step 1040, data transmission and/or signaling transmission and/or system information transmission is performed.

The transmission mode of data and/or signaling and/or system information corresponds to at least one configuration in the network DTX configurations.

Alternatively, the transmission mode of data and/or signaling and/or system information corresponds to at least one configuration in the network DRX configurations.

In some embodiments based on FIG. 9 and/or FIG. 10, the network DTX configurations and/or the network DRX configurations are determined based on network states.

Alternatively, the network DTX configurations and/or the network DRX configurations are determined based on traffic transmission requirements.

In some embodiments based on FIG. 9 and/or FIG. 10, the network states includes a base station state or a cell state.

The base station state includes at least one of: a state of the base station corresponding to the serving cell of the terminal, a state of the base station corresponding to the primary cell of the terminal, a state of the base station corresponding to the primary secondary cell of the terminal, a state of the neighbor base station of the base station corresponding to the serving cell of the terminal, a state of the neighbor base station of the base station corresponding to the primary cell of the terminal, a state of the neighbor base station of the base station corresponding to the primary secondary cell of the terminal, or a state of the base station in the ANR list.

The cell state includes at least one of: a state of the serving cell of the terminal, a state of the primary cell of the terminal, a state of the primary secondary cell of the terminal, a state of the neighbor cell of the terminal, a state of the cell of the neighbor base station of the base station, or a state of the cell of the base station in the ANR list.

In some embodiments based on FIG. 9 and/or FIG. 10, the network states are of two or more types, e.g., network on/network off, network on/network off/DRX/DTX, and low load/medium load/high load states.

In some embodiments based on FIG. 9 and/or FIG. 10, the data and/or signaling and/or system information includes at least one of the following:
common information or signaling; or
terminal-specific information or signaling or data.

In some embodiments based on FIG. 9 and/or FIG. 10, the common information or signaling includes at least one of: a synchronization signal block (SSB), a master information block (MIB), a system information block SIB1, other SIBs, a common reference signal (RS), or a physical random access channel (PRACH).

The terminal-specific information or signaling or data includes at least one of: a terminal-specific reference signal, a physical downlink control channel (PDCCH), a physical uplink control channel (PUCCH), downlink data, uplink data, a dynamic scheduling resource (DG), semi-persistent scheduling (SPS), a configured grant (CG), or a scheduling request (SR).

In some embodiments based on FIG. 9 and/or FIG. 10, the network DTX configurations include at least one of: a network DTX indication or a configuration parameter of network DTX.

In some embodiments based on FIG. 9 and/or FIG. 10, the network DRX configurations include at least one of: a network DRX indication or a network DRX configuration parameter.

In some embodiments based on FIG. 9 and/or FIG. 10, the network DTX configuration parameter includes at least one of: a DTX cycle, a DTX pattern, DTX on information, DTX off information, a DTX on duration, a DTX off duration, a sequence of turning on and turning off DTX in a DTX cycle, a sequence of turning on and turning off DTX in a DTX pattern, a DTX start offset, a DTX on start time, a DTX off start offset, and a DTX off start time.

The network DRX configuration parameter includes at least one of: a DRX cycle, a DRX pattern, DRX on information, DRX off information, a DRX on duration, a DRX off duration, a sequence of turning on and turning off DRX in one DRX cycle, a sequence of turning on and turning off DRX in one DRX pattern, a DRX start offset, a DRX on start time, a DRX off start offset, and a DRX off start time.

In some embodiments, the DTX configuration or DTX pattern includes at least one cycle, e.g., a long cycle and/or a short cycle.

In some embodiments, the DTX configuration or DTX pattern includes a DTX on/DTX off configuration, e.g., a long DTX on configuration/short DTX off configuration, different DTX on start times/DTX off start times, and different DTX on/DTX off durations.

In some embodiments, in the DTX cycle or DTX pattern, the DTX on occurs first and then the DTX off.

In some embodiments, the DRX configuration or DRX pattern includes at least one cycle, e.g., a long cycle and/or a short cycle.

In some embodiments, the DRX configuration or DRX pattern includes a DRX on/DRX off configuration, e.g., a long DRX on configuration/short DRX off configuration, different DRX on start times/DRX off start times, and different DRX on/DRX off durations.

In some embodiments, in the DRX cycle or DRX pattern, the DRX on occurs first and then the DRX off.

In summary, based on the methods according to the embodiments of FIG. 9 and/or FIG. 10, network DRX and/or DTX configurations are introduced, and based on the configurations, transmission is performed, so as to achieve the purpose of network energy saving.

FIG. 11 illustrates a schematic flowchart of a method for saving energy according to some exemplary embodiments of the present disclosure. For example, the method is applicable to a terminal, and therefore the method includes at least part of the following steps.

In step 1120, BWP switching is performed based on first information.

In some embodiments, the terminal receives the first information via a common search space; or
receives the first information via a UE-specific search space; or
receives the first information via a first search space,
which is configured by the network or predefined, and optionally, the first search space is a specific search space.

In some embodiments, the common search space and/or the UE-specific search space are shared.

In some embodiments, the common search space and/or the UE-specific search space are independently configured.

In some embodiments, the first information is received via the common search space, or the first information is received via the UE-specific search space, or the first information is received via the first search space.

In some embodiments, in the case that a first condition is satisfied, the first information is received via the common search space or the first search space, and it is also understood that in the case that the first condition is satisfied, the terminal performs the BWP switching based on the first information. The first condition includes at least one of the following:
the network state is a first state;
the terminal acquires that the network state is the first state; BWP switching is indicated; or
a BWP identifier for the BWP switching is indicated.

The first state includes at least one state of network being unloaded, network load being in a first load state, a network sleep state, a network DRX state, a network DTX state, or an energy saving state. In some embodiments, the first load state is a low load state.

In some embodiments, in the case that a second condition is satisfied, the first information is received via the UE-specific search space or the first search space, and it is also understood that in the case that the second condition is satisfied, the terminal performs the BWP switching based on the first information. The second condition includes at least one of the following:
the network state is a second state;
the terminal acquires that the network state is the second state;
BWP switching is indicated; or
a BWP identifier for the BWP switching is indicated.

The second state includes at least one state of network load being in a second load state, a network non-sleep state, a network normal transmission state, or a non-energy saving state. In some embodiments, the second load state is a high load state.

In some embodiments, in the case that a third condition is satisfied, the terminal switches the BWP to a second BWP based on the first information, and it is also understood that in the case that the third condition is satisfied, the terminal performs the BWP switching based on the first information. The third condition includes at least one of the following:
the network state is a first state;
the terminal acquires that the network state is the first state;
it is instructed to perform the BWP switching;
BWP switching is indicated; or
a BWP identifier for the BWP switching is indicated.

The first state includes at least one state of network being unloaded, network load being in a first load state, a network sleep state, a network DRX state, a network DTX state, and an energy saving state. In some embodiments, the first load state is a low load state.

The second BWP includes at least one of a common BWP, a small bandwidth BWP, a BWP indicated for the BWP switching, a default BWP, a first BWP, a BWP with a bandwidth less than a first threshold, a historically used BWP, a historically activated BWP, an activated or used BWP before a currently activated BWP is used, one activated BWP immediately before a currently activated BWP, and a BWP with a bandwidth greater than a second threshold.

Being instructed to perform BWP switching includes at least one of: a BWP switching indicator bit or a BWP switching indication identifier.

In some embodiments, in the case that a fourth condition is satisfied, the terminal switches the BWP to a third BWP based on the first information, and it is also understood that in the case that the fourth condition is satisfied, the terminal performs the BWP switching based on the first information. The fourth condition includes at least one of the following:
the network state is a second state;
the terminal acquires that the network state is the second state;
it is instructed to perform the BWP switching;
BWP switching is indicated; and
a BWP identifier for the BWP switching is indicated.

The second state includes at least one state of network load being in a second load state, a network non-sleep state, a network normal transmission state, or a non-energy saving state. In some embodiments, the second load state is a high load state.

The third BWP includes at least one of a common BWP, a large bandwidth BWP, a BWP indicated for the BWP switching, a default BWP, a first BWP, a historically used BWP, a historically activated BWP, an activated or used BWP before a currently activated BWP is used, one activated BWP immediately before a currently activated BWP, and a BWP with a bandwidth greater than a second threshold.

Being instructed to perform BWP switching includes at least one of a BWP switching indicator bit and a BWP switching indication identifier.

In some embodiments, the second BWP includes a default BWP that is the same as, or different from, the default BWP included in the third BWP.

In some embodiments, the second BWP includes a first BWP that is the same as, or different from, the first BWP included in the third BWP.

For example, in the case that the network load becomes low, it is reasonable for a smart network to implement switch of all UEs to a common small bandwidth. In addition, in the case that the network load becomes large, the network switches all UEs to a common large bandwidth, or indicates for the UE to switch back to the BWP that is previously activated for the UE (it is reasonable that a smart network implementation is to switch all UEs to a common and small bandwidth if the network load becomes low. And if the network load becomes larger, the network can switch all UEs to a (or another) common and large bandwidth or indicate the UEs to switch back to the BWP that is previous activated for the UE). In some embodiments, the common small bandwidth BWP and the common large bandwidth BWP are different bandwidth parts, or they have some overlapping areas.

In some embodiments, the terminal performs the BWP switching based on the first information, which includes:
performing the BWP switching, by the terminal, in the case of receiving the first information; or
performing BWP switching, by the terminal, at an indicated switching time (as shown in FIG. 14) in the case of receiving the first information; or
performing BWP switching, by the terminal, at a moment that a reception start time of the first information plus a first offset duration (as shown in FIG. 15); or
performing BWP switching, by the terminal, at a moment that a reception end time of the first information plus a second offset duration; or
performing BWP switching, by the terminal, at a moment that a decoding start time of the first information plus a third offset duration; or
performing BWP switching, by the terminal, at a moment that a decoding end time of the first information plus a fourth offset duration.

In some embodiments, the methods according to the embodiments are applicable to Pcell switch and/or Scell reactivation.

FIG. 12 illustrates a schematic flowchart of a method for saving energy according to some embodiments of the present disclosure. For example, the method is applicable to a network, and therefore the method includes at least part of the following steps.

In step 1220, a terminal is explicitly or implicitly instructed to perform BWP switching based on first information.

In some embodiments, the methods according to the embodiments are applicable to Pcell switch and/or Scell reactivation.

In some embodiments based on FIG. 11 and/or FIG. 12, at least one piece of information in the first information is associated with network energy saving, or at least one piece of information in the first information is associated with network states, or at least one piece of information in the first information is associated with network configurations, or at least one piece of information in the first information is determined based on network energy saving.

In some embodiments based on FIG. 11 and/or FIG. 12, the switched BWP includes at least one of the following:
a default BWP;
a historically used BWP;
a historically activated BWP;
an activated or used BWP before a currently activated BWP is used;
one activated BWP immediately before a currently activated BWP;
a first BWP, optionally, the first BWP being a specific BWP;
a BWP indicated by the first information;
a BWP indicated by second information;
a common BWP;
large bandwidth BWP;
a small bandwidth BWP; and
a specific BWP.

The historically used BWP includes at least one of the following: a previously used BWP, e.g., a used BWP before a currently used BWP, a used BWP immediately before a currently used BWP, or a BWP before a BWP switching indication, or a BWP used when receiving the first information, or a BWP used when receiving the second information, or a BWP determined by a rule in previously used BWPs.

The historically activated BWP includes at least one of the following: a previously activated BWP, e.g., an activated or used BWP before a currently activated BWP, an activated BWP immediately before a currently activated BWP, or a BWP before a BWP switching indication, or a BWP activated when receiving the first information, or a BWP activated when receiving the second information, or a BWP determined by a rule in previously activated BWPs.

The specific BWP is: a BWP used in the case of BWP switching, or a BWP used at different times or patterns, or a BWP used in different states or configurations, or a BWP used for different times of BWP switching.

In some embodiments based on FIG. 11 and/or FIG. 12, the first information is carried in an SIB, or in first downlink information; in some embodiments, the first downlink information includes at least one of the following:
group DCI;
group RNTI scrambled DCI;
a PDSCH scheduled by the group RNTI scrambled DCI;
a PDSCH scheduled by group DCI;
a group PDSCH; and
a group downlink MAC protocol data unit (PDU).

In some embodiments based on FIG. 11 and/or FIG. 12, the second information is carried in an SIB, or in first downlink information.

In some embodiments based on FIG. 11 and/or FIG. 12, the MAC PDU carries one or more MAC sub-PDUs, each MAC sub-PDU corresponding to one piece of terminal-specific (UE-specific) information; or, the MAC PDU carries one or more MAC sub-PDUs, each MAC sub-PDU corresponding to information of one terminal group; or, the MAC PDU carries one or more MAC sub-PDUs, each MAC sub-PDU corresponding to information of one cell level.

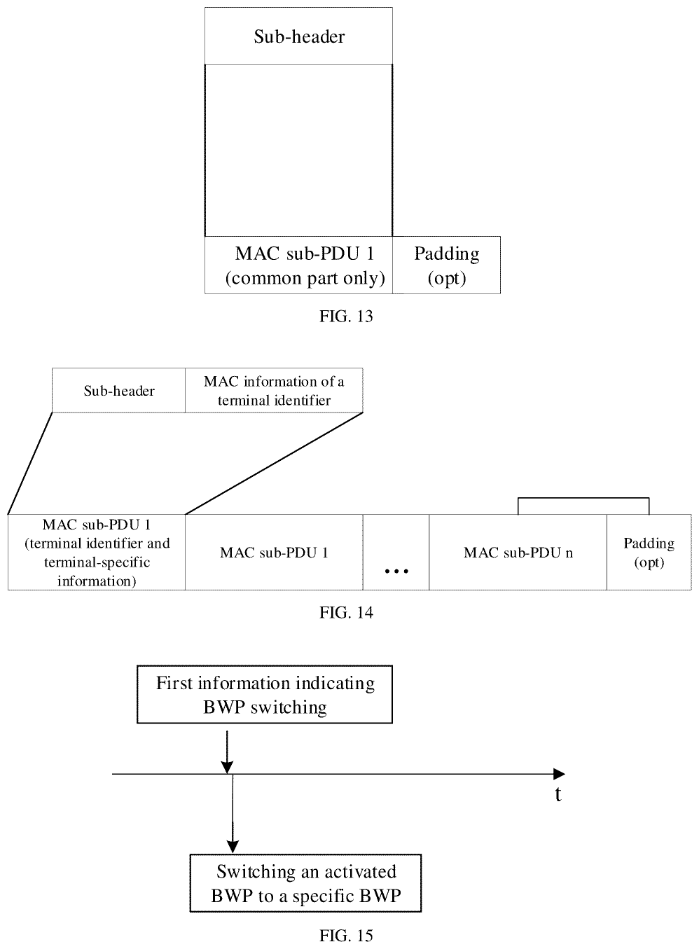

In some embodiments, the MAC sub-PDU carries a common part, as shown in FIG. 13. In some embodiments, the MAC sub-PDU carries a UE ID or UE-specific information, as shown in FIG. 14.

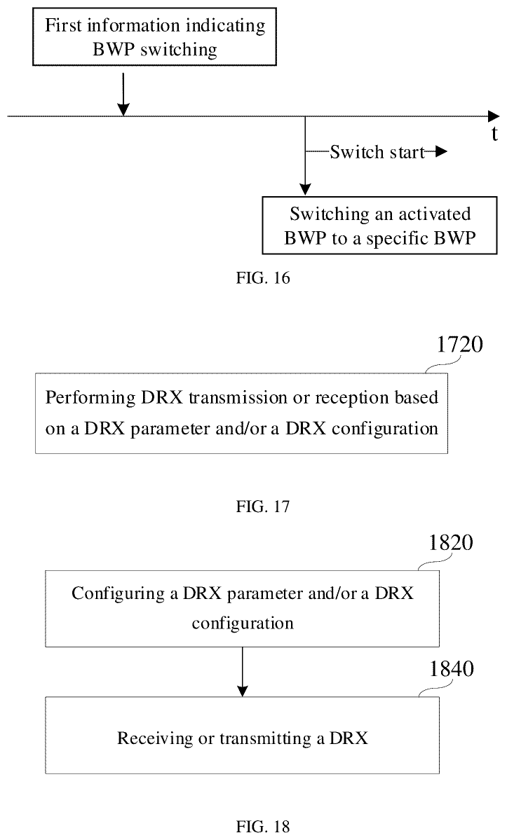

In some embodiments, the UE performs the BWP switching in response to receiving the first information, as shown in FIG. 15. In some embodiments, the UE performs the BWP switching at an indicated switching time in response to receiving the first information, as shown in FIG. 16.

In some embodiments based on FIG. 11 and/or FIG. 12, the first BWP is configured by the network or predefined. In some embodiments, the first BWP includes at least one of the following: a network energy saving BWP, a non-network energy saving BWP, a BWP with a specific identifier (e.g., a BWP index), and an initial BWP.

In some embodiments based on FIG. 11 and/or FIG. 12, the first information includes at least one of the following:
a BWP switching indication;
a network state indication or a network state change;
a switched BWP identifier;
a network load condition;
whether the network energy saving is prioritized;
whether transmission performance is prioritized;
an energy saving technology indication;
an energy saving configuration;
an energy saving indication;
the network state indication;
whether a network state transition indication is received;
a network DTX transmission configuration;
a network off indication;
a network on indication;
a network DRX transmission configuration;
a network DTX configuration;
a network DRX transmission configuration;
indicated information that is allowed to be transmitted/sent/received;
a switching time; or
a switching delay offset.

In summary, based on the methods according to the embodiments of FIG. 11 and/or FIG. 12, a method for BWP switching is introduced for different network loads. Alternatively, a unified or specific method for BWP switching is given according to whether network energy saving is required.

FIG. 17 illustrates a schematic flowchart of a method for saving energy according to some embodiments of the present disclosure. For example, the method is applicable to a terminal, and therefore the method includes at least part of the following steps.

In step 1720, DRX transmission or reception is performed based on a DRX parameter and/or a DRX configuration.

The DRX parameter and/or the DRX configuration is specific to the terminal.

In some embodiments, the DRX parameter and/or the DRX configuration is all or a part of DRX parameters in the related art, or all or a part of DRX parameters in the first communication protocol version, or all or a part of newly added DRX parameters in the first communication protocol version. In some embodiments, the first communication protocol version includes a 3GPP R18 version and/or a subsequent version of the 3GPP R18 version and/or a subsequent version of the 3GPP.

In some embodiments, performing the DRX transmission or reception based on the DRX parameter and/or the DRX configuration includes:
performing an updated DRX parameter or configuration based on the DRX parameter and/or the DRX configuration and network indication information; or
performing the DRX transmission or reception according to an updated DRX parameter or configuration based on the DRX parameter and/or the DRX configuration and network indication information.

In some embodiments, performing the DRX transmission or reception based on the DRX parameter and/or the DRX configuration includes:
receiving at least one set of DRX parameters, where the at least one set of DRX parameters corresponds to different indexes; and receiving a first index, and performing the DRX transmission or reception based on the DRX parameter corresponding to the first index; or
receiving at least one set of DRX configurations, where the at least one set of DRX configurations corresponds to different indexes; and receiving a second index, and performing the DRX transmission or reception based on the DRX configuration corresponding to the second index.

In some embodiments, performing the DRX transmission or reception based on the DRX parameter and/or the DRX configuration further includes at least one of the following:
receiving two sets of DRX parameters, and switching DRX parameters in the two sets of DRX parameters, where
in some embodiments, the terminal receives a DRX parameter switch indication, or receives an update indication of a network state or a network load or whether to save energy, and the terminal switches the DRX parameters in the two sets of DRX parameters;
receiving two sets of DRX configurations, and switching DRX configurations in the two sets of DRX configurations;
using a DRX parameter with a short on duration or a long cycle in the case of energy saving;
using a DRX configuration with a short on duration or a long cycle in the case of energy saving;
using a DRX parameter with a long on duration or a short cycle in the case of non-energy saving;
using a DRX configuration with a long on duration or a short cycle in the case of non-energy saving;
using a first set of DRX parameters in at least one set of DRX parameters in the case of energy saving;
using a first set of DRX configurations in at least one set of DRX configurations in the case of energy saving;
using a second set of DRX parameters in the at least one set of DRX parameters in the case of non-energy saving; or
using a second set of DRX configurations in the at least one set of DRX configurations in the case of non-energy saving.

In some embodiments, performing the DRX transmission or reception based on the DRX parameter and/or the DRX configuration includes:
receiving at least one set of DRX parameter configurations, where the at least one set of DRX parameter configurations corresponds to different network states or network loads or requirements on whether to save energy; and receiving an indicated network state or network load or requirement on whether to save energy, and determining the used DRX parameter based on the indicated network state or network load or requirement on whether to save energy and performing the DRX transmission or reception; or
receiving at least one set of DRX configurations, where the at least one set of DRX configurations corresponds to different network states or network loads or requirements on whether to save energy; and receiving an indicated network state or network load or requirement on whether to save energy, and determining the used DRX configuration based on the indicated network state or network load or requirement on whether to save energy and performing the DRX transmission or reception.

In some embodiments, performing the DRX transmission or reception based on the DRX parameter and/or the DRX configuration includes:
receiving configurations of a set of DRX parameters, where the set of DRX parameters corresponds to a network state or network load or requirement on whether to save energy; and
receiving an indicated network state or network load or requirement on whether to save energy, and determining whether to use the set of DRX parameters based on the indicated network state or network load or requirement on whether to save energy, and performing the DRX transmission or reception; or
receiving a set of DRX configurations, where the set of DRX configurations corresponds to a network state or network load or requirement on whether to save energy; and receiving an indicated network state or network load or requirement on whether to save energy, and determining whether to use the set of DRX configurations based on the indicated network state or network load or requirement on whether to save energy, and performing the DRX transmission or reception.

In some embodiments, performing the DRX transmission or reception based on the DRX parameter and/or the DRX configuration further includes:
receiving an updated DRX parameter or DRX configuration at a cell or terminal group level; and
performing the DRX transmission or reception by using the updated DRX parameter or DRX configuration.

The updated DRX parameter or configuration at the cell or terminal group level is indicated by common DCI or a common MAC CE or system information or a PDSCH carried by the common DCI or a common PDSCH.

FIG. 18 illustrates a schematic flowchart of a method for saving energy according to some embodiments of the present disclosure. For example, the method is applicable to a network, and therefore the method includes at least part of the following steps.

In step 1820, a DRX parameter and/or a DRX configuration is configured.

The DRX parameter and/or the DRX configuration is specific to the terminal.

In some embodiments, the DRX parameter and/or the DRX configuration and network indication information are transmitted.

In some embodiments, at least one set of DRX parameters are transmitted, where the at least one set of DRX parameters corresponds to different indexes; or
at least one set of DRX configurations are transmitted, where the at least one set of DRX configurations corresponds to different indexes, and a second index is transmitted.

In some embodiments, two sets of DRX parameters are transmitted, and/or two sets of DRX configurations are transmitted.

In some embodiments, at least one set of DRX parameters are transmitted, where the at least one set of DRX parameters corresponds to different network states or network loads or requirements on whether to save energy; and an indicated network state or network load or requirement on whether to save energy is transmitted; or
at least one set of DRX configurations are transmitted, where the at least one set of DRX configurations corresponds to different network states or network loads or requirements on whether to save energy; and an indicated network state or network load or requirement on whether to save energy is transmitted.

In some embodiments, configurations of a set of DRX parameters are transmitted, where the set of DRX parameters corresponds to a network state or network load or requirement on whether to save energy; and an indicated network state or network load or requirement on whether to save energy is transmitted; or
a set of DRX configurations are transmitted, where the set of DRX configurations corresponds to a network state or network load or requirement on whether to save energy; and an indicated network state or network load or requirement on whether to save energy is transmitted.

In some embodiments, an updated DRX parameter or DRX configuration at a cell or terminal group level is transmitted, where the updated DRX parameter or configuration at the cell or terminal group level is indicated by common DCI or a common MAC CE or system information or a PDSCH carried by the common DCI or a common PDSCH.

In step 1840, a DRX is received or transmitted.

The transmission/sending/reception manner of the DRX corresponds to the configurations of at least one set of parameters in the DRX parameters.

Alternatively, the transmission/sending/reception manner of the DRX corresponds to at least one set of configurations in the DRX configurations.

In summary, based on the methods according to the embodiments of FIG. 17 and/or FIG. 18, a method for using or updating DRX parameters based on an energy saving requirement or a network state is introduced. The complexity or delay can be reduced while the network energy saving is achieved.

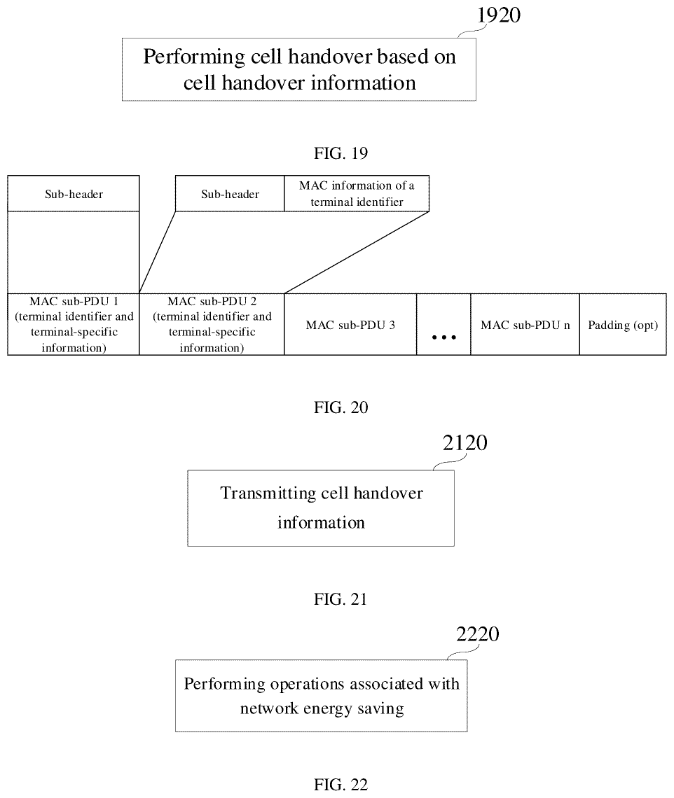

FIG. 19 illustrates a schematic flowchart of a method for saving energy according to some embodiments of the present disclosure. For example, the method is applicable to a terminal, and therefore the method includes at least part of the following steps.

In step 1920, cell handover is performed based on cell handover information.

The cell handover information is terminal group handover information or cell level handover information.

In some embodiments, the cell handover is performed in at least one of the following cases:
a current serving cell is off;
network energy saving is performed;
the network load is in a first load state, where the first load state is a low load state in some embodiments; or
the network is unloaded.

FIG. 21 illustrates a schematic flowchart of a method for saving energy according to some embodiments of the present disclosure. For example, the method is applicable to a network, and therefore the method includes at least part of the following steps.

In step 2120, cell handover information is transmitted.

The cell handover information is terminal group handover information or cell level handover information.

In some embodiments, the cell handover information is transmitted in at least one of the following cases:
a current serving cell is off;
network energy saving is performed;
the network load is in a first load state, where the first load state is a low load state in some embodiments; and
the network is unloaded.

In some embodiments based on FIG. 19 and/or FIG. 21, the cell handover information includes a handover parameter or configuration, and the handover parameter or configuration includes: a common part and/or a terminal-specific part.

In some embodiments based on FIG. 19 and/or FIG. 21, the common part is carried in a SIB or first downlink information, and the terminal-specific part is carried in second downlink information; or
the common part and the terminal-specific part are both carried in the first downlink information.

In some embodiments based on FIG. 19 and/or FIG. 21, the first downlink information includes at least one of the following:
group DCI;
group RNTI scrambled DCI;
a PDSCH scheduled by the group RNTI scrambled DCI, such as in a random access procedure (RAR) manner;
a PDSCH scheduled by the group DCI, such as in an RAR manner; or
a common PDSCH; and
the second downlink information includes at least one of the following:
group DCI;
group RNTI scrambled DCI;
a PDSCH scheduled by the group RNTI scrambled DCI, such as in an RAR manner; or
a common PDSCH.

In some embodiments based on FIG. 19 and/or FIG. 21, pieces of information of the terminal-specific part are in one-to-one correspondence with MAC sub-PDUs, and one or more of the MAC sub-PDUs are carried in a MAC PDU, as shown in FIG. 20.

In some embodiments based on FIG. 19 and/or FIG. 21, the MAC PDU further carries one or more MAC sub-PDUs corresponding to information of the common part.

In some embodiments based on FIG. 19 and/or FIG. 21, the information of the terminal-specific part corresponds to all terminals in a cell, or a terminal at a first position, or a first group of terminals.

The first position may be an absolute geographic position, such as latitude and longitude; or a relative geographic position, such as a relative position from a base station, or a number of spaced cells from a cell, or a relative position from a terminal; or a coordinate interval, such as a coordinate interval in a latitude-longitude coordinate system or a coordinate interval in a virtual coordinate system.

The first group of terminals may be a specific group of terminals configured by the network device, or indicated by the network device, or predefined by the communication protocol; and the specific group of terminals may also be a group of terminals determined according to rules configured by the network device or indicated by the network device or predefined by the communication protocol.

In some embodiments based on FIG. 19 and/or FIG. 21, the information of the common part corresponds to all the terminals in the cell, or the terminal at the first position, or the first group of terminals, or all or a part of the terminals in the first group.

The first position may be an absolute geographic position, such as latitude and longitude; or a relative geographic position, such as a relative position from a base station, or a number of spaced cells from a cell, or a relative position from a terminal; or a coordinate interval, such as a coordinate interval in a latitude-longitude coordinate system or a coordinate interval in a virtual coordinate system.

The first group of terminals may be a specific group of terminals configured by the network device, or indicated by the network device, or predefined by the communication protocol; and the specific group of terminals may also be a group of terminals determined according to rules configured by the network device or indicated by the network device or predefined by the communication protocol. All or the part of the terminals in the first group may be specific terminals configured by the network device, or indicated by the network device, or predefined by the communication protocol; and the specific terminals may also be determined according to rules configured by the network device or indicated by the network device or predefined by the communication protocol.

In summary, the method according to the embodiments provides a method for group handover in a network energy saving condition, which achieves the purpose of energy saving and reduces the delay/overhead.

FIG. 22 illustrates a schematic flowchart of a method for saving energy according to some exemplary embodiments of the present disclosure. For example, the method is applicable to a network, and therefore the method includes at least part of the following steps:

In step 2220, operations associated with network energy saving are performed.

The operations associated with the network energy saving include at least one of the following:
receiving reported assistance information, where the assistance information is used for assisting the network energy saving;
transmitting network configurations, where at least one of the network configurations is associated with the network energy saving;
transmitting network states, where at least one of the network states is associated with the network energy saving;
transmitting a network state change, where at least one of the changed network states is associated with the network energy saving;
transmitting a network DTX configuration and/or a network DRX configuration, where at least one of the network DTX configuration and/or the network DRX configuration is associated with the network energy saving;
transmitting first information for performing the BWP switching, where at least one piece of information in the first information is associated with the network energy saving, or at least one piece of information in the first information is associated with the network state, or at least one piece of information in the first information is associated with the network configuration, or at least one piece of information in the first information is determined based on the network energy saving;
transmitting a DRX parameter and/or a DRX configuration, and performing the DRX transmission or reception, where the DRX parameter and/or the DRX configuration is specific to the terminal; and
transmitting cell handover information, where the cell handover information is terminal group handover information or cell level handover information.

In some embodiments, in the case that one configured grant (CG) period is configured with a non-integer period or a non-integer parameter, a physical uplink shared channel (PUSCH) opportunity is calculated based on a first formula. The parameter associated with the CG period in the first formula is rounded up or rounded down.

In some embodiments, in the case that one semi-persistent scheduling (SPS) period is configured with a non-integer period or a non-integer parameter, a physical downlink shared channel (PDSCH) opportunity is calculated based on a second formula. The parameter associated with the SPS period in the second formula is rounded up or rounded down.

In summary, in the method according to the embodiments, the network performs the operations associated with network energy saving to achieve the purpose of network energy saving.

According to some embodiments of the present disclosure, a calculation formula of a PUSCH/PDSCH opportunity is provided.

The calculation method of the non-integer configured PUSCH/PDSCH opportunity according to the embodiments is used for transmitting data of a service, where the service may be network energy saving, or a service associated with the network energy saving, or another service independent of the network energy saving. The PUSCH/PDSCH opportunity may be one PUSCH/PDSCH opportunity or a plurality of PUSCH/PDSCH opportunities. The related calculation method of the calculation formula of the PUSCH/PDSCH opportunity according to the embodiments may be used independently of the network energy saving technology (for example, for a specific service or a specific scenario independent of the network energy saving technology), or may be used together with the network energy saving technology.

A PUSCH opportunity is calculated based on a first formula in the case that one CG period is configured with a non-integer period or a non-integer parameter.

A PUSCH opportunity is calculated based on a second formula in the case that one SPS period is configured with a non-integer period or a non-integer parameter.

A parameter associated with the CG period in the first formula is rounded up or rounded down, and a parameter associated with the SPS period in the second formula is rounded up or rounded down.

In some embodiments, the parameter associated with the CG period or the SPS period includes at least one of the following: N, a period, a symbol length, a number of slots per frame, a position of an initial first PDSCH transmission of the SPS, and a position of an initial first PUSCH transmission of the SPS.

In some embodiments, the position of the initial first PDSCH transmission of the SPS includes: at least one of an SFN of the first transmission of the PDSCH (i.e., an SFN at which the PDSCH transmission starts), a slot of the first transmission of the PDSCH (i.e., a slot at which the PDSCH transmission starts), and a symbol of the first transmission of the PDSCH (i.e., a symbol at which the PDSCH transmission starts).

The position of the initial first PUSCH transmission of the SPS includes at least one of: an SFN of the first transmission of the PUSCH (i.e., an SFN at which the PUSCH transmission starts), a slot of the first transmission of the PUSCH (i.e., a slot at which the PUSCH transmission starts), and a symbol of the first transmission of the PUSCH (i.e., a symbol at which the PUSCH transmission starts).

In some embodiments, the parameter associated with the CG period includes: N×first periodicity, or N×first periodicity plus a position of an initial first PUSCH transmission of the CG. The N represents an N^{th} CG period or an N^{th} PUSCH opportunity or a first PUSCH opportunity in the N^{th} CG period, and the first periodicity is associated with the SPS period and the symbol length.

In some embodiments, the first PUSCH opportunity in the N^{th} CG period is a first occurred PUSCH opportunity; or a specific PUSCH opportunity configured by the network device or indicated by the network device or predefined by the communication protocol; or a PUSCH opportunity determined according to rules configured by the network device or indicated by the network device or predefined by the communication protocol.

In some embodiments, the parameter associated with the SPS period includes: N×second periodicity, or N×second periodicity×the number of slots per frame divided by 10, or N×second periodicity plus the position of the initial first PDSCH transmission of the SPS, or N×second periodicity×the number of slots per frame divided by 10 plus the position of the initial first PDSCH transmission of the SPS. The N represents an N^{th} SPS period or an n^{th} PDSCH opportunity or a first PDSCH opportunity in the N^{th} SPS period, and the second periodicity is associated with the SPS period and the symbol length.

In some embodiments, the first PDSCH opportunity in the N^{th} SPS period is a first occurred PDSCH opportunity; or a specific PDSCH opportunity configured by the network device or indicated by the network device or predefined by the communication protocol; or a PDSCH opportunity determined according to rules configured by the network device or indicated by the network device or predefined by the communication protocol.

In some embodiments, the first periodicity is equal to the CG period divided by each symbol length, or the period of each packet divided by each symbol length, or is a configured periodicity.

In addition, the second periodicity is equal to the SPS period divided by each symbol length, or the period of each packet divided by each symbol length, or is a configured periodicity.

In some embodiments, the first periodicity and/or the second periodicity is associated with a traffic period or a packet rate or a non-integer traffic period.

In some embodiments, the first periodicity and/or the second periodicity is represented by a non-integer number (e.g., with a fractional part) or a fractional number.

In some embodiments, the first periodicity and/or the second periodicity is equal to the traffic period or the packet rate or the non-integer traffic period, which can also be a variation of the traffic period or the packet rate or the non-integer traffic period (e.g., one using frames per second (fps), and the other one using ms/symbol, etc.), or a reduction of a fraction of the traffic period or the packet rate or the non-integer traffic period (e.g., a fractional or decimal or not-carry number (integer or decimal) or a carry number (integer or decimal)).

Exemplarily, in CG type 1:
After an uplink grant is configured for CG type 1, a medium access control (MAC) entity shall consider sequentially that an N^{th} (N>0) uplink grant occurs in the symbol for which:
After an uplink grant is configured for a configured grant Type 1, the MAC entity shall consider sequentially that the N^{th} (N>=0) uplink grant occurs in the symbol for which:

```
  [(SFN × numberOfSlotsPerFrame × numberOfSymbolsPerSlot) + (slot number in the frame
× numberOfSymbolsPerSlot) + symbol number in the slot] =
  (timeReferenceSFN × numberOfSlotsPerFrame × numberOfSymbolsPerSlot
  + timeDomainOffset × numberOfSymbolsPerSlot + S + ceiling{N × periodicity})
  modulo (1024 × numberOfSlotsPerFrame × numberOfSymbolsPerSlot)
or,
  [(SFN × numberOfSlotsPerFrame × numberOfSymbolsPerSlot) + (slot number in the frame
× numberOfSymbolsPerSlot) + symbol number in the slot] =
  (ceiling{timeReferenceSFN × numberOfSlotsPerFrame × numberOfSymbolsPerSlot
  + timeDomainOffset × numberOfSymbolsPerSlot + S + N × periodicity})
  modulo (1024 × numberOfSlotsPerFrame × numberOfSymbolsPerSlot)
```

SFN is the system frame number; numberOfSlotsPerFrame is the number of slots per frame; numberOfSymbolsPerSlot is the number of symbols per slot; slot number in the frame is a slot number in the frame; symbol number in the slot is a symbol number in the slot; timeReferenceSFN is a time domain reference SFN for determining an SFN of an offset of resources in the time domain; timeDomainOffset is a resource offset at SFN=0 in the time domain; S is a start symbol; ceiling represents rounding up; periodicity=configured period value divided by each symbol length (e.g., milliseconds), or periodicity=each packet (e.g., for a protocol data unit (PDU) set, a period of burst) divided by each symbol length, or a configured period value.

In some embodiments, the first periodicity and/or the second periodicity is associated with a traffic period or a packet rate or a non-integer traffic period.

In some embodiments, the first periodicity and/or the second periodicity is represented by a non-integer number (e.g., with a fractional part) or a fractional number.

In some embodiments, the first periodicity and/or the second periodicity is equal to the traffic period or the packet rate or the non-integer traffic period, which can also be a variation of the traffic period or the packet rate or the non-integer traffic period (e.g., one using frames per second (fps), and the other one using ms/symbol, etc.), or a reduction of a fraction of the traffic period or the packet rate or the non-integer traffic period (e.g., a fractional or decimal or not-carry number (integer or decimal) or a carry number (integer or decimal)).

The above calculation method is an exemplary calculation method of rounding up, and the rounding down case may be represented by floor.

In CG type 2:
After an uplink grant is configured for CG type 2, the MAC entity shall consider sequentially that an N^{th} (N>0) uplink grant occurs in the symbol for which:
After an uplink grant is configured for a configured grant Type 2, the MAC entity shall consider sequentially that the N^{th} (N>=0) uplink grant occurs in the symbol for which:

```
  [(SFN × numberOfSlotsPerFrame × numberOfSymbolsPerSlot) + (slot number in the frame
× numberOfSymbolsPerSlot) + symbol number in the slot] =
  [(SFN_{start time} × numberOfSlotsPerFrame × numberOfSymbolsPerSlot
  + slot_{start time} × numberOfSymbolsPerSlot + symbol_{start time}) + ceiling { N × periodicity}]
  modulo (1024 × numberOfSlotsPerFrame × numberOfSymbolsPerSlot)
or,
  [(SFN × numberOfSlotsPerFrame × numberOfSymbolsPerSlot) + (slot number in the frame
× numberOfSymbolsPerSlot) + symbol number in the slot] =
  [ceiling{ (SFN_{start time} × numberOfSlotsPerFrame × numberOfSymbolsPerSlot
  + slot_{start time} × numberOfSymbolsPerSlot + symbol_{start time}) + N × periodicity}]
  modulo (1024 × numberOfSlotsPerFrame × numberOfSymbolsPerSlot)
```

SFN_{start time} represents an SFN of the first transmission of the PUSCH, slot_{start time} represents a slot of the first transmission of the PUSCH, and symbol_{start time} represents a symbol of the first transmission of the PUSCH.

In some embodiments, the periods in CG type 1 and CG type 2 are in a millisecond level, or in a frame per second (FPS) unit, or expressed in fractions, or in a symbol level, or expressed in non-integer (e.g., with a fractional part).

The above calculation method is an exemplary calculation method of rounding up, and the rounding down case may be represented by floor.

In some embodiments, a calculation formula of the corresponding CG position is similar to the calculation formula of the SPS to calculate the position of the CG PUSCH.

Exemplarily, in option 1 of the SPS (rounding up case):
After a downlink assignment is configured for the SPS, the MAC entity shall consider sequentially that an N^{th} downlink assignment occurs in the slot for which:

```
  (numberOfSlotsPerFrame × SFN + slot number in the frame) =
  [(numberOfSlotsPerFrame × SFN_{start time} + slot_{start time}) + ceiling{N × periodicity ×
numberOfSlotsPerFrame / 10}] modulo (1024 × numberOfSlotsPerFrame)
  or,
  (numberOfSlotsPerFrame × SFN + slot number in the frame) =
  [ceiling{ (numberOfSlotsPerFrame × SFN_{start time} + slot_{start time}) + N × periodicity ×
numberOfSlotsPerFrame / 10}] modulo (1024 × numberOfSlotsPerFrame)
```

SFN_{start time} represents an SFN of the first transmission of the PDSCH and slot_{start time} represents a slot of the first transmission of the PDSCH, where the configured downlink assignment was (re-)initialized.

where SFN_{start time} and slot_{start time} are the SFN and slot, respectively, of the first transmission of PDSCH where the configured downlink assignment was (re-)initialised.

In option 2 of the SPS (rounding down case):
After a downlink assignment is configured for the SPS, the MAC entity shall consider sequentially that an N^{th} downlink assignment occurs in the slot for which:

```
  (numberOfSlotsPerFrame × SFN + slot number in the frame) =
  [(numberOfSlotsPerFrame × SFN_{start time} + slot_{start time}) + floor{N × periodicity ×
numberOfSlotsPerFrame / 10}] modulo (1024 × numberOfSlotsPerFrame)
or,
  (numberOfSlotsPerFrame × SFN + slot number in the frame) =
  [floor{ (numberOfSlotsPerFrame × SFN_{start time} + slot_{start time}) + N × periodicity ×
numberOfSlotsPerFrame / 10}] modulo (1024 × numberOfSlotsPerFrame)
```

SFN_{start time} represents an SFN of the first transmission of the PDSCH and slot_{start time} represents a slot of the first transmission of the PDSCH, where the configured downlink assignment was (re-)initialized.

In some embodiments, the periodicity is the second periodicity, or a configured periodicity.

In some embodiments, the configured period value is associated with a traffic period or a packet rate or a non-integer traffic period.

In some embodiments, the configured period value is represented by a non-integer number (e.g., with a fractional part) or a fractional number.

In some embodiments, the configured or used period value is equal to the traffic period or the packet rate or the non-integer traffic period, which can also be a variation of the traffic period or the packet rate or the non-integer traffic period (e.g., one using frames per second (fps), and the other one using ms/symbol, etc.), or a reduction of a fraction of the traffic period or the packet rate or the non-integer traffic period (e.g., a fractional or decimal or not-carry number (integer or decimal) or a carry number (integer or decimal)).

In some embodiments, the period in the SPS is in a millisecond level, or in a frame per second (FPS) unit, or expressed in fractions, or in a symbol level, or expressed in non-integer.

In some embodiments, the following is an example of a CG/SPS calculation formula (the difference from the previous calculation formula is whether square brackets or parentheses are present).

```
SPS PDSCH:
  (numberOfSlotsPerFrame × SFN + slot number in the frame) =
ceiling{[(numberOfSlotsPerFrame × SFNstart time + slotstart time) + N × periodicity ×
numberOfSlotsPerFrame / 10]} modulo (1024 × numberOfSlotsPerFrame)
The periodicities supported for SPS are {100/3ms, 50/3ms, 100/9ms, 25/3ms}.
That is, the periodicities supported for SPS are {100/3ms, 50/3ms, 100/9ms, 25/3ms}.
CG Type 1:
  [(SFN × numberOfSlotsPerFrame × numberOfSymbolsPerSlot) + (slot number in the frame
× numberOfSymbolsPerSlot) + symbol number in the slot] =
  ceiling{(timeReferenceSFN × numberOfSlotsPerFrame × numberOfSymbolsPerSlot +
timeDomainOffset × numberOfSymbolsPerSlot + S + N × periodicity)} modulo (1024 ×
numberOfSlotsPerFrame × numberOfSymbolsPerSlot)
CG Type 2:
  [(SFN × numberOfSlotsPerFrame × numberOfSymbolsPerSlot) + (slot number in the frame
× numberOfSymbolsPerSlot) + symbol number in the slot] =
  ceiling{[(SFNstart time × numberOfSlotsPerFrame × numberOfSymbolsPerSlot + slotstart
time × numberOfSymbolsPerSlot + symbolstart time) + N × periodicity]} modulo (1024 ×
numberOfSlotsPerFrame × numberOfSymbolsPerSlot)
```

In addition, in the network configuration, a case where a plurality of CG/SPS periods correspond to one service or logical channel or transmission may be present, or a case where a plurality of CG/SPS configurations correspond to one traffic period (that is, one traffic period is provided with resource positions corresponding to a plurality of CG/SPS configurations) may be present, or a case where a plurality of CG/SPS configurations are provided with the same period but different resource configuration sizes and/or start positions may be present. This may occur in a network energy saving environment or may be independent of the network energy saving (i.e., no coupling to the network energy saving is present).

With the presence of a plurality of PUSCH/PDSCH opportunities, in the case that a plurality of PUSCH/PDSCH transmission opportunities correspond to one service, or a plurality of CGs/SPSs (and thus a plurality of PUSCH/PDSCH opportunities) are used for transmitting one service, or a plurality of CG/SPS periods correspond to one service or logical channel or transmission, or a plurality of CG/SPS configurations correspond to one traffic period (that is, one traffic period is provided with resource positions corresponding to a plurality of CG/SPS configurations), or a plurality of CG/SPS configurations are provided with the same period but different resource configuration sizes and/or start positions, the terminal or network may indicate whether a part of the opportunities are used or canceled, or the terminal or network may indicate which CG/SPS configuration or CG/SPS configurations (or PUSCH/PDSCH opportunities) are activated and/or deactivated. Further, at least one of the following may be included:
indicating one or more positions or identifiers of the used or activated opportunities, or the used or activated SPS/CG index, or the used or activated CG/SPS group index;
indicating one or more positions or identifiers of the unused or deactivated opportunities, or the unused or deactivated SPS/CG index, or the unused or deactivated CG/SPS group index;
indicating whether a part of the opportunities of the current period are used or canceled, or indicating whether a part of opportunities of one or more subsequent periods are used or canceled;
indicating one or more positions or identifiers of the used or canceled opportunities;
indication by one of MAC CE, RRC, CG-UCI, SR, UCI, DCI, or DL DG-DCI (indication information carried on DG);
indication by a specific opportunity in a period, such as the first opportunity, the first N (N may be 1) used or canceled opportunities, or the first X used or canceled opportunities, X being a positive integer; or
the part of used or canceled opportunities being, for example, the last used or canceled opportunity, or the last Y used or canceled opportunities, Y being a positive integer.

In some embodiments, the above indication is indicated in the first or specific opportunity or opportunities or CG/SPS index, or indicated in a currently activated or used opportunity or CG/SPS index.

In some embodiments, the resources or resource sizes of a plurality of CGs/SPSs in a period or the resources or resource sizes of a plurality of CG/SPS configurations are the same or different.

In some embodiments, the resources or resource sizes of a plurality of CGs/SPSs in a period or the resources or resource sizes of a plurality of CG/SPS configurations correspond to different traffic data transmission requirements or traffic data volume transmission requirements or packet sizes or data rates.

In some embodiments, the resources or resource sizes of a plurality of CGs/SPSs in a period or the resources or resource sizes of a plurality of CG/SPS configurations are the same, and at least a part of the plurality of CGs/SPSs are used together for traffic transmission, or specific traffic transmission, or logical channel (LCH) transmission, or data transmission.

In some embodiments, the resources or resource sizes of a plurality of CGs/SPSs in a period or the resources or resource sizes of a plurality of CG/SPS configurations are different, and one of the CGs/SPSs is used for traffic transmission or specific traffic transmission or LCH transmission or data transmission, or at least a part of the plurality of CGs/SPSs are used together for traffic transmission or specific traffic transmission or LCH transmission or data transmission.

In some embodiments, packet arrival rates are {30, 60, 90, 120} fps, and the corresponding traffic periods are {33.33, 16.67, 11.11, 8.33} ms. Accordingly, CG/SPS periods are {33.33, 16.67, 11.11, 8.33} ms. That is, the CG/SPS period configuration is not limited. In this case, the CG/SPS position calculated by using the rounding up (ceiling) or rounding down (floor) formula may be considered, which may result in a deviation in the transmission position in the calculation result.

In some embodiments, packet arrival rates are {30, 60, 90, 120} fps, and the corresponding traffic periods are {33.33, 16.67, 11.11, 8.33} ms. Accordingly, for 33.33 ms, 11.11 ms, and 8.33 ms, the CG/SPS periods are {33.33, 11.11, 8.33} ms, and for 16.67 ms, the CG/SPS period is limited to 16.66 ms. That is, the CG/SPS period is not limited for 33.33 ms, 11.11 ms, and 8.33 ms, but should be limited for 16.67 ms. Otherwise, the CG/SPS position calculated by using the rounding up or rounding down formula is deviated, which is not favorable for traffic transmission. Further, in the case that the decimal place of the value corresponding to the traffic period is greater than 0.5, the CG/SPS configuration of the traffic period needs to be restricted (i.e., the next decimal place is not carried over). In other embodiments, it is considered whether to perform carry-over for the traffic period after considering the symbol or the CG/SPS period after considering the symbol. For example, it is considered whether to perform carry-over for the period, or whether to perform carry-over for a value obtained by dividing the period by the symbol length.

In some embodiments, packet arrival rates are {30, 60, 90, 120} fps, and the corresponding traffic periods are {33.33, 16.67, 11.11, 8.33} ms. Accordingly, CG/SPS periods are {33.33, 16.67, 11.11, 8.33} ms. That is, the CG/SPS period configuration is not limited. In this case, the CG/SPS position calculated by using the rounding up+rounding down formulas may be considered, which avoids a deviation in the transmission position, and ensures the traffic transmission. For example, the following conditions may be used to determine whether to use the rounding up or rounding down operation. For example, in the case that the condition meets N mod M=0, the rounding down calculation formula is used, otherwise the rounding up formula is used. N is a value of N used in the calculation formula of the CG/SPS opportunity to calculate the current position, or N is an N^{th} CG/SPS opportunity after a start CG/SPS position or period, or N is a value obtained by subtracting 1 from an N^{th} position corresponding to the CG/SPS configuration. M is the denominator corresponding to fps (e.g., for 60 fps, i.e., 50/3, the denominator is 3).

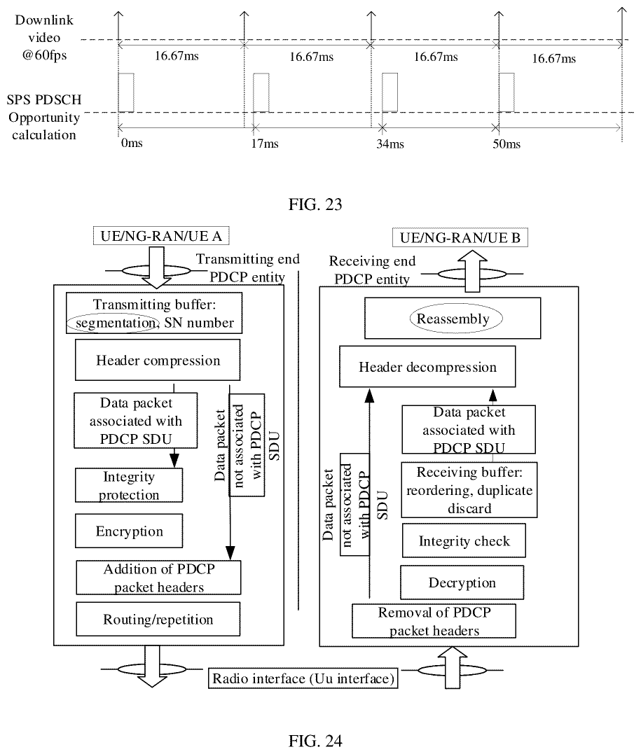

An example of a possible calculated CG/SPS position is shown in FIG. 23. In the case that the packet arrival rate is 60 fps, the traffic period is 16.67 (1000/60) ms, and in the case that the rounding up calculation method is used, the opportunity positions of the SPS PDSCH at Oms, 17 ms, 34 ms, 50 ms, etc., as shown in FIG. 23 can be calculated. In the case that the rounding down calculation method is used, the opportunity positions of the SPS PDSCH at Oms, 16 ms, 33 ms, 50 ms, etc., can be calculated. The calculated CG/SPS positions in another calculation method may be opportunity positions of the SPS PDSCH at Oms, 17 ms, 34 ms, 51 ms, etc. The calculated position of the CG is the same, or similar (e.g., considering the symbol factor).

In some embodiments, for XR traffic or for non-integer traffic periods (e.g., with packet arrival rates of {30, 60, 90, 120} fps, which correspond to traffic periods {33.33, 16.67, 11.11, 8.33} ms), a CG/SPS pattern configuration manner is used for configuring the transmission resources or positions for the XR traffic or non-integer period traffic. In some embodiments, the CG/SPS pattern configuration is periodic. The CG/SPS pattern configuration method may be independent of the network energy saving technology (for example, for a specific service or a specific scenario independent of the network energy saving technology), or may be used together with the network energy saving technology.

In some embodiments, a plurality of PUSCH/PDSCH transmission opportunities are configured in each or a specific CG/SPS pattern. The plurality of PUSCH/PDSCH transmission opportunities are discontinuous transmission opportunities.

In some embodiments, for the PUSCH/PDSCH transmission opportunities, an interval between a certain transmission opportunity and a previous closest transmission opportunity is fixed (except for an interval between the last two transmission opportunities).

At least one of the CG/SPS pattern configuration, the CG/SPS pattern period, the interval between transmission opportunities, and a number of transmission opportunities in each CG/SPS pattern is associated with at least one of the traffic period, the traffic arrival time, and the data (traffic packet) size. For example, for XR video traffic of DL 60 fps, the period of the SPS pattern configuration is 50 ms. In each SPS pattern, 3 SPS-PDSCH transmission opportunities may be configured, with an interval of 17 ms between each SPS transmission opportunity and a previous closest SPS-PDSCH transmission opportunity (except for an interval between the last two SPS-PDSCH transmission opportunities).

A possible CG/SPS pattern is shown in FIG. 23. In the case that the packet arrival rate is 60 fps, the traffic period is 16.67 (1000/60) ms, and in the case that the rounding up calculation method is used, the opportunity positions of the SPS PDSCH at Oms, 17 ms, 34 ms, 50 ms, etc., as shown in FIG. 23 can be calculated. In the case that the rounding down calculation method is used, the opportunity positions of the SPS PDSCH at Oms, 16 ms, 33 ms, 50 ms, etc., can be calculated. The calculated CG/SPS positions in another calculation method may be opportunity positions of the SPS PDSCH at Oms, 17 ms, 34 ms, 51 ms, etc. The calculated position of the CG is the same, or similar (e.g., considering the symbol factor).

In some embodiments, for the relevant content of the period of the present disclosure, for example, for at least one of the non-integer period, the XR period, the fractional period, the fps identified period, the period with decimal places, and the like, the configuration to be finally used is configured during the RRC configuration or MAC usage, and/or an equivalent definition for configuration usage is executed. (e.g., for CG/SPS)

For example, in the RRC configuration:

| | |
|---|---|
| periodicityExt2-r18 | ENUMERATED {ms1000/30, |

```
ms1000/60, ms1000/90, ms1000/120, spare4, spare3, spare2, spare1}
  OPTIONAL -- Need R;
    or,
  [[
```

| | |
|---|---|
| periodicityExt2-r18 | ENUMERATED {ms33dot33, |

```
ms16dot66, ms11dot11, ms8dot33, spare4, spare3, spare2, spare1}
  OPTIONAL -- Need R
  ]];
    or,
```

| | |
|---|---|
| periodicityExt2-r18 | ENUMERATED |

{msOnethousandthirty, msOnethousandsixty, msOnethousandninety,
msOnethousandonehundredtwenty, spare4, spare3, spare2, spare 1}
OPTIONAL -- Need R.

For example, in the MAC or RRC configuration:
periodicityExt2
This field is used to calculate the periodicity for UL transmission without UL grant for type 1 and type 2 (see TS 38.321 [3], clause 5, 8.2). If this field is present, the field periodicity and periodicityExt is ignored. The used is periodicityExt2 divided by the symbol length associated with the configured BWP SCS.
   or,
This field is used to calculate the periodicity for UL transmission without UL grant for type 1 and type 2 (see TS 38.321 [3], clause 5, 8.2). The used is periodicityExt2 divided by the symbol length associated with the configured BWP SCS.
   or,
The following periodicities are supported for CG depending on the configured subcarrier spacing [symbols]:

·{100/3/14, 50/3/14, 100/9/14, 25/3/14} for 15 kHz;
·0.5 × {100/3/14, 50/3/14, 100/9/14, 25/3/14} for 30 kHz;
·0.25 × {100/3/14, 50/3/14, 100/9/14, 25/3/14} for 60 kHz with normal CP;
·0.25 × {100/3/12, 50/3/12, 100/9/12, 25/3/12} for 60 kHz with ECP;
·0.125 × {100/3/14, 50/3/14, 100/9/14, 25/3/14} for 120 kHz;
·0.0625 × {100/3/14, 50/3/14, 100/9/14, 25/3/14} for 480 kHz;
·0.03125 × {100/3/14, 50/3/14, 100/9/14, 25/3/14} for 960 kHz.

In some embodiments, a first data packet is segmented at an SDAP layer or a PDCP layer in the case that the terminal is a transmitting end; and a second data packet is reassembled at the SDAP layer or the PDCP layer in the case that the terminal is a receiving end.

A size of the first data packet exceeds a maximum data packet limit of the PDCP, and/or a size of the second data packet does not exceed the maximum data packet limit of the PDCP. In some embodiments, the method is applicable to the network energy saving, or a service associated with the network energy saving, or another service independent of the network energy saving. The method is applicable in scenarios with a limitation that the transmission of higher-layer data is greater than the transmission of lower-layer data, such as a scenario where the transmitted data is greater than 9,000 bytes required by the PDCP.

In the case that the method is applied in other transmission scenarios independent of the network energy saving, such as extended-range (XR) traffic, the data packet size is large and the data packet size is variable. For example:
30 Mbps: average packet size: 0.5 Mbit=62,500 bytes, and minimum packet to maximum packet: 0.5-1.5 times the average packet size; and
60 Mbps: average packet size: 1 Mbit=125,000 bytes, and minimum packet to maximum packet: 0.5-1.5 times the average packet size.

However, a data packet size limit of no more than 9,000 bytes is now imposed on packet data convergence protocol (PDCP) service data units (SDUs), i.e., the maximum supported size of a PDCP SDU is 9,000 bytes, and the maximum supported size of a PDCP control PDU is 9,000 bytes.

Therefore, it is possible that the size of an XR data packet exceeds the data packet size limit of the PDCP. For solving this problem, the following functions may be introduced. For a transmitting end and/or a receiving end (the transmitting end includes a terminal and/or a base station, and the receiving end includes a terminal and/or a base station):

For the transmitting end, a segmentation function is added. In some embodiments, the function is implemented in a service data adaptation protocol (SDAP) (e.g., after identifying a PDU set, or before routing), or in a PDCP.

For the receiving end, a reassembly function is added. In some embodiments, the function is implemented in the SDAP, or in the PDCP.

For example, for PDCP implementation, an architecture as shown in FIG. 24 may be used.

In addition, in the network configuration, it may be configured that the traffic period is not divisible by 10240 ms, or the DRX cycle is not divisible by 10240 ms, or the CG/SPS period is not divisible by 10240 ms, or the periodic DRX pattern is not divisible by 10240 ms, or the periodic CG/SPS pattern is not divisible by 10240 ms. This may occur in a network energy saving environment or may be independent of the network energy saving, i.e., no coupling to the network energy saving is present.

I. In the case that the above calculation method is used in another service independent of the network energy saving, in the case that the traffic period is not divisible by 10240 ms, or the DRX cycle is not divisible by 10240 ms, or the CG/SPS period is not divisible by 10240 ms, or the periodic DRX pattern is not divisible by 10240 ms, or the periodic CG/SPS pattern is not divisible by 10240 ms, the calculated PUSCH/PDSCH/DRX position according to the position of SFN start (SNF0) after wrap around is problematic in the case that the SFN is wrapped around.

For example, there is a periodicity mismatch issue for XR traffic. For a video traffic of 60 FPS, the traffic periodicity is 1000/60=50/3 (ms), which means the traffic pattern repeats in every 50 ms. However, the SFN runs from 0 to 1024, and 10240 ms is not an integer multiple of 50 ms.

There is a periodicity mismatch issue for XR traffic: For a video traffic of 60 FPS, the traffic periodicity is 1000/60=50/3 (ms), which means the traffic pattern repeats in every 50 ms. However, the SFN runs from 0 to 1024, and 10240 ms is not an integer multiple of 50 ms.

Therefore, in this case, it is necessary to solve the inability to be divisible by 10240 ms. The following three cases can be mainly distinguished.

In case 1, the DRX cycle is not divisible by 10240 ms, and the existing calculation formula of the DRX start (long and short DRX cycle starts) is modified. The position of the SFN or subframe or slot to the left of the equal sign is the accumulated SFN or subframe or slot. Specifically, the accumulated SFN or subframe or slot is a total accumulated SFN or subframe or slot from a DRX start position (since receiving the DRX configuration, a position of a first DRX after receiving the DRX configuration, or a calculated position of a first DRX cycle, or a calculated first position for the DRX configuration) to a current SFN or subframe or slot. In the case that the accumulated SFN or subframe or slot satisfies the equation, the SFN or subframe or slot is a calculated start position of the DRX cycle.

For example (for a subframe, or for ms, for example):

1. A short DRX cycle is used for a DRX group, and [A] modulo (drx-ShortCycle)=(drx-StartOffset) modulo (drx-ShortCycle).

If the Short DRX cycle is used for a DRX group, and [A] modulo (drx-ShortCycle)=(drx-StartOffset) modulo (drx-ShortCycle).

In the formula, A=(SFN×10)+subframe number, where A is the accumulated subframe, or SFN is the accumulated SFN.

2. A drx-on duration timer is started for this DRX group after drx-SlotOffset from the beginning of the subframe.

Start drx-on duration timer for this DRX group after drx-SlotOffset from the beginning of the subframe.

For another example:

1. A long DRX cycle is used for a DRX group, and [B] modulo (drx-ShortCycle)=(drx-StartOffset) modulo (drx-ShortCycle).

If the Long DRX cycle is used for a DRX group, and [B] modulo (drx-LongCycle)=drx-StartOffset.

In the formula, B=(SFN×10)+subframe number, where B is the accumulated subframe, or SFN is the accumulated SFN.

2. A drx-on duration timer is started for this DRX group after drx-SlotOffset from the beginning of the subframe.

Start drx-onDurationTimer for this DRX group after drx-SlotOffset from the beginning of the subframe.

For another example:

1. A short DRX cycle is used for a DRX group, and [A] modulo (drx-ShortCycle-slot-level)=(drx-StartOffset) modulo (drx-ShortCycle).

If the Short DRX cycle is used for a DRX group, and [A] modulo (drx-ShortCycle-slot-level)=(drx-StartOffset) modulo ((drx-ShortCycle-slot-level). In the formula, A=(SFN×10)+subframe number+slot.

In the formula, A is the accumulated slot.

2. A drx-on duration timer is started for this DRX group from the beginning of the subframe.

Start drx-on duration timer for this DRX group from the beginning of the subframe.

In case 2, the periodic DRX pattern is not divisible by 10240 ms, and the position used in the formula is the accumulated SFN or subframe or slot for calculating a position of each pattern of, or a start position of, the periodic DRX pattern. Specifically, the accumulated SFN or subframe or slot is a total accumulated SFN or subframe or slot from a DRX start position (since receiving the DRX configuration, a position of a first DRX after receiving the DRX configuration, or a calculated position of a first DRX cycle, or a calculated first position for the DRX configuration) to a current SFN or subframe or slot. In the case that the accumulated SFN or subframe or slot satisfies the equation, the SFN or subframe or slot is a calculated start position of the DRX cycle.

For example, a position of an N^{th} pattern is: [the start position of the pattern+N×pattern period] module (10240 ms)=(pattern-StartOffset). The start position of the pattern is at a slot level or a subframe level. In some embodiments, a drx-on duration timer of the first DRX is turned on at this slot of the pattern.

For example, a position of an N^{th} pattern is: [the start position of the pattern+N×pattern period] module (10240 ms)=(pattern-StartOffset). The start position of the pattern is at a subframe level. In some embodiments, a drx-on duration timer of the first DRX is turned on after a slot offset at the beginning of this subframe of the pattern.

In case 3, the periodic CG/SPS pattern is not divisible by 10240 ms, and the position used in the formula is the accumulated SFN or subframe or slot for calculating a position of each pattern of, or a start position of, the periodic CG/SPS pattern. Specifically, the accumulated SFN or subframe or slot is a total accumulated SFN or subframe or slot from a DRX start position (since receiving the DRX configuration, a position of a first DRX after receiving the DRX configuration, or a calculated position of a first DRX cycle, or a calculated first position for the DRX configuration) to a current SFN or subframe or slot. In the case that the accumulated SFN or subframe or slot satisfies the equation, the SFN or subframe or slot is a calculated start position of the DRX cycle.

For example, a position of an N^{th} pattern is: [the start position of the pattern+N×pattern period] module (10240 ms)=(pattern-StartOffset). The start position of the pattern is at a slot level or a subframe level. In some embodiments, this slot position in the pattern is the CG/SPS opportunity position, or this slot position in the pattern+symbol offset is the CG/SPS opportunity position.

For example, a position of an N^{th} pattern is: [the start position of the pattern+N×pattern period] module (10240 ms)=(pattern-StartOffset). The start position of the pattern is at a symbol level. In some embodiments, this symbol in the pattern starts with the CG/SPS opportunity position.

In addition, in the network configuration, a case where one CG/SPS period is provided with a plurality of PUSCH/PDSCH opportunities, or a plurality of CGs/SPSs (and thus a plurality of PUSCH/PDSCH opportunities) are used for transmitting one service, may be present. This may occur in a network energy saving environment or may be independent of the network energy saving. That is, no coupling to the network energy saving is present.

II. In the case that one CG/SPS period is provided with a plurality of PUSCH/PDSCH opportunities, or a plurality of CGs/SPSs (and thus a plurality of PUSCH/PDSCH opportunities) are used for transmitting one service, the terminal or network may indicate whether a part of the opportunities is used or canceled. Further, at least one of the following may be included:
indicating whether a part of the opportunities of the current period are used or canceled, or indicating whether a part of opportunities of one or more subsequent periods are used or canceled;
indicating one or more positions or identifiers of the used or canceled opportunities;
indication by one of MAC CE, RRC, CG-UCI, SR, UCI, DCI, or DL DG-DCI (indication information carried on DG);
indication by a specific opportunity in a period, such as the first opportunity, the first N (N may be 1) used or canceled opportunities, or the first X used or canceled opportunities; and
the part of used or canceled opportunities being, for example, the last used or canceled opportunity, or the last Y used or canceled opportunities.

In some embodiments, the above indication is indicated in the first or specific opportunity or opportunities or CG/SPS index, or indicated in a currently activated or used opportunity or CG/SPS index.

In addition, cases are present where transmission or data arrives, or packet loss processing is to be performed on remaining PDUs (for example, PDUs that have not been transmitted in one PDU set, or PDUs that have not been transmitted or successfully transmitted to meet a PDU set delay budget) or PDU sets, or it is indicated that packet loss processing can be performed on remaining PDUs or PDU sets, or packet loss processing is supported on remaining PDUs or PDU sets. This may occur in a network energy saving environment or may be independent of the network energy saving. That is, no coupling to the network energy saving is present.

III. In the case that packet loss processing is to be performed on remaining PDUs (for example, PDUs that have not been transmitted in one PDU set, or PDUs that have not been transmitted or successfully transmitted to meet a PDU set delay budget) or PDU sets, or it is indicated that packet loss processing can be performed on remaining PDUs or PDU sets, or packet loss processing is supported on remaining PDUs or PDU sets, an execution body of the packet loss processing may be a transmitting end and/or a receiving end.

The transmitting end determines whether to perform the packet loss processing based on indication information of the receiving end. The packet loss processing is performed in response to receiving the indication information or feedback (e.g., non-acknowledge (NACK) for a PDU set or PDUs of a PDU set). The indication information may be transmitted by the receiving end itself. For example, the receiving end may transmit the indication information to the transmitting end in one of the following cases: the receiving end performs the packet loss processing in the case that at least one of a state report trigger, a PSDB timeout, a PDU set transmission failure (such as NACK), or a PDU transmission failure (such as NACK) in a PDU set is satisfied; or the receiving end transmits the indication information in response to a request from the transmitting end, for example, in the case that the receiving end receives a request feedback and/or a request state report. The indication information may be a packet loss indication, or a state report, or a PSDB timeout.

The receiving end determines whether to perform the packet loss processing based on indication information from the transmitting end. In response to at least one of receiving the indication information, receiving a packet loss indication, the PSDB timing out, or receiving an indication of the PDU transmission status, for example, where partial data has not been transmitted or successfully transmitted (for a PDU set or PDUs of a PDU set), the packet loss processing is performed. The indication information may be transmitted by the transmitting end itself (for example, in the case that a state report, a PSDB timeout, or a requirement on confirming the PDU or PDU set transmission state is satisfied, the transmitting end performs the packet loss processing), or may be transmitted in response to a request from the receiving end (for example, requesting the transmitting end to transmit the indication information).

The receiving end determines whether to perform the packet loss processing based on the transmission status of PDU sets or packets of PDU sets. For example, the packet loss processing is performed in response to at least one of exceeding the PSDB, determining that a packet has not been transmitted or the transmission is not completed, or receiving an NACK feedback.

The transmitting end determines whether to perform the packet loss processing based on the transmission status of PDU sets or packets of PDU sets. For example, the packet loss processing is performed in response to at least one of exceeding the PSDB, determining that a packet has not been transmitted or the transmission is not completed, or receiving an NACK feedback.

In addition, for the problem that whether SRs (PUCCH) and PUSCHs in different PUCCH groups can be transmitted simultaneously or whether they overlap, one of the following solutions can be considered. The problem may occur in a network energy saving environment or may be independent of the network energy saving. That is, no coupling to the network energy saving is present.

In Option 1, the determination of overlap or the limitation on simultaneous transmission is in the same PUCCH group. For example, only a conflict between an SR and a PUSCH in the same PUCCH group is considered to be a conflict, or considered to affect the identification of prioritization, or considered to affect the determination of prioritization resources. Alternatively, it is considered that an SR (PUCCH) and a PUSCH in the same PUCCH group cannot be transmitted simultaneously. Alternatively, it is considered that an SR (PUCCH) and a PUSCH in different PUCCH groups can be transmitted simultaneously.

A protocol that may be influenced is TS 38.321. The following is an example of protocol influence:

When the MAC entity is configured with Ich-basedPrioritization, for each uplink grant delivered to the HARQ entity and whose associated PUSCH can be transmitted by lower layers, the MAC entity shall:
1> if this uplink grant is received in a Random Access Response (i.e. in a MAC RAR or fallback RAR), or addressed to Temporary C-RNTI, or is determined as specified in clause 5.1.2a for the transmission of the MSGA payload:
2> consider this uplink grant as a prioritized uplink grant.
1> else if this uplink grant is addressed to CS-RNTI with NDI=1 or C-RNTI:
2> if there is no overlapping PUSCH duration of a configured uplink grant which was not already de-prioritized, in the same BWP, whose priority is higher than the priority of the uplink grant; and
2> if there is no overlapping PUCCH resource with an SR transmission which was not already de-prioritized, in the same PUCCH group, and the simultaneous transmission of the SR and the uplink grant is not allowed by configuration of simultaneousPUCCH-PUSCH or simultaneousPUCCH-PUSCH-SecondaryPUCCHgroup, and the priority of the logical channel that triggered the SR is higher than the priority of the uplink grant:
3> consider this uplink grant as a prioritized uplink grant;
3> consider the other overlapping uplink grant(s), if any, as a de-prioritized uplink grant(s);
3> consider the other overlapping SR transmission(s), if any, as a de-prioritized SR transmission(s);
3> if the de-prioritized uplink grant(s) is a configured uplink grant configured with autonomousTx whose PUSCH has already started:
4> stop the configuredGrantTimer for the corresponding HARQ process of the de-prioritized uplink grant(s);
4> stop the cg-RetransmissionTimer for the corresponding HARQ process of the de-prioritized uplink grant(s).
1> else if this uplink grant is a configured uplink grant:
2> if there is no overlapping PUSCH duration of another configured uplink grant which was not already de-prioritized, in the same BWP, whose priority is higher than the priority of the uplink grant; and
2> if there is no overlapping PUSCH duration of an uplink grant addressed to CS-RNTI with NDI=1 or C-RNTI which was not already de-prioritized, in the same BWP, whose priority is higher than or equal to the priority of the uplink grant; and
2> if there is no overlapping PUCCH resource with an SR transmission which was not already de-prioritized, in the same PUCCH group, and the simultaneous transmission of the SR and the uplink grant is not allowed by configuration of simultaneousPUCCH-PUSCH or simultaneousPUCCH-PUSCH-SecondaryPUCCHgroup, and the priority of the logical channel that triggered the SR is higher than the priority of the uplink grant:
3> consider this uplink grant as a prioritized uplink grant;
3> consider the other overlapping uplink grant(s), if any, as a de-prioritized uplink grant(s);
3> if the de-prioritized uplink grant(s) is a configured uplink grant configured with autonomousTx whose PUSCH has already started:
4> stop the configuredGrantTimer for the corresponding HARQ process of the de-prioritized uplink grant(s);
4> stop the cg-RetransmissionTimer for the corresponding HARQ process of the de-prioritized uplink grant(s).
3> consider the other overlapping SR transmission(s), if any, as a de-prioritized SR transmission(s).

As long as at least one SR is pending, the MAC entity shall for each pending SR:
1> if the MAC entity has no valid PUCCH resource configured for the pending SR:
2> initiate a Random Access procedure (see clause 5.1) on the SpCell and cancel the pending SR.
1> else, for the SR configuration corresponding to the pending SR:
2> when the MAC entity has an SR transmission occasion on the valid PUCCH resource for SR configured; and
2> if sr-ProhibitTimer is not running at the time of the SR transmission occasion; and
2> if the PUCCH resource for the SR transmission occasion does not overlap with a measurement gap:
3> if the PUCCH resource for the SR transmission occasion overlaps with neither a UL-SCH resource, in the same PUCCH group, and whose simultaneous transmission with the SR is not allowed by configuration of simultaneousPUCCH-PUSCH or simultaneousPUCCH-PUSCH-SecondaryPUCCHgroup nor an SL-SCH resource; or
3> if the MAC entity is able to perform this SR transmission simultaneously with the transmission of the SL-SCH resource; or
3> if the MAC entity is configured with Ich-basedPrioritization, and the PUCCH resource for the SR transmission occasion does not overlap with the PUSCH duration of an uplink grant received in a Random Access Response or with the PUSCH duration of an uplink grant addressed to Temporary C-RNTI or with the PUSCH duration of a MSGA payload, in the same PUCCH group, and the PUCCH resource for the SR transmission occasion for the pending SR triggered as specified in clause 5.4.5 overlaps with any other UL-SCH resource(s), in the same PUCCH group, and the physical layer can signal the SR on one valid PUCCH resource for SR, and the priority of the logical channel that triggered SR is higher than the priority of the uplink grant(s) for any UL-SCH resource(s) where the uplink grant was not already de-prioritized and its simultaneous transmission with the SR is not allowed by configuration of simultaneousPUCCH-PUSCH or simultaneousPUCCH-PUSCH-SecondaryPUCCHgroup, and the priority of the uplink grant is determined as specified in clause 5.4.1; or
   (omited)

In Option 2, an RRC configuration is introduced. In the case that only the network configures the configuration, the determination of overlap or the limitation on simultaneous transmission is in the same PUCCH group. For example, only a conflict between an SR and a PUSCH in the same PUCCH group is considered to be a conflict, or considered to affect the identification of prioritization, or considered to affect the determination of prioritization resources. Alternatively, it is considered that an SR (PUCCH) and a PUSCH in the same PUCCH group cannot be transmitted simultaneously. Alternatively, it is considered that an SR (PUCCH) and a PUSCH in different PUCCH groups can be transmitted simultaneously. Further, the RRC configuration and a UE capability are introduced. In the case that only the network configures the configuration and the UE is provided with the capability, the determination of overlap or the limitation on simultaneous transmission is in the same PUCCH group. For example, only a conflict between an SR and a PUSCH in the same PUCCH group is considered to be a conflict, or considered to affect the identification of prioritization, or considered to affect the determination of prioritization resources. Alternatively, it is considered that an SR (PUCCH) and a PUSCH in the same PUCCH group cannot be transmitted simultaneously. Alternatively, it is considered that an SR (PUCCH) and a PUSCH in different PUCCH groups can be transmitted simultaneously. Further, the RRC configuration and a UE capability are introduced.

A protocol that may be influenced is at least one of TS 38.321, TS38.331, or TS38.306. The following is an example of protocol influence:

When the MAC entity is configured with Ich-basedPrioritization, for each uplink grant delivered to the HARQ entity and whose associated PUSCH can be transmitted by lower layers, the MAC entity shall:
1> if this uplink grant is received in a Random Access Response (i.e. in a MAC RAR or fallback RAR), or addressed to Temporary C-RNTI, or is determined as specified in clause 5.1.2a for the transmission of the MSGA payload:
2> consider this uplink grant as a prioritized uplink grant.
1> else if this uplink grant is addressed to CS-RNTI with NDI=1 or C-RNTI:
2> if there is no overlapping PUSCH duration of a configured uplink grant which was not already de-prioritized, in the same BWP, whose priority is higher than the priority of the uplink grant; and
2> if there is no overlapping PUCCH resource with an SR transmission which was not already de-prioritized and the simultaneous transmission of the SR and the uplink grant is not allowed by configuration of simultaneousPUCCH-PUSCH or simultaneousPUCCH-PUSCH-SecondaryPUCCHgroup or simultaneousPUCCH-PUSCH-differentPUCCHgroup, and the priority of the logical channel that triggered the SR is higher than the priority of the uplink grant:
3> consider this uplink grant as a prioritized uplink grant;
3> consider the other overlapping uplink grant(s), if any, as a de-prioritized uplink grant(s);
3> consider the other overlapping SR transmission(s), if any, as a de-prioritized SR transmission(s);
3> if the de-prioritized uplink grant(s) is a configured uplink grant configured with autonomousTx whose PUSCH has already started:
4> stop the configuredGrantTimer for the corresponding HARQ process of the de-prioritized uplink grant(s);
4> stop the cg-RetransmissionTimer for the corresponding HARQ process of the de-prioritized uplink grant(s).
1> else if this uplink grant is a configured uplink grant:
2> if there is no overlapping PUSCH duration of another configured uplink grant which was not already de-prioritized, in the same BWP, whose priority is higher than the priority of the uplink grant; and
2> if there is no overlapping PUSCH duration of an uplink grant addressed to CS-RNTI with NDI=1 or C-RNTI which was not already de-prioritized, in the same BWP, whose priority is higher than or equal to the priority of the uplink grant; and
2> if there is no overlapping PUCCH resource with an SR transmission which was not already de-prioritized and the simultaneous transmission of the SR and the uplink grant is not allowed by configuration of simultaneousPUCCH-PUSCH or simultaneousPUCCH-PUSCH-SecondaryPUCCHgroup or simultaneousPUCCH-PUSCH-differentPUCCHgroup, and the priority of the logical channel that triggered the SR is higher than the priority of the uplink grant:
3> consider this uplink grant as a prioritized uplink grant;
3> consider the other overlapping uplink grant(s), if any, as a de-prioritized uplink grant(s);
3> if the de-prioritized uplink grant(s) is a configured uplink grant configured with autonomousTx whose PUSCH has already started:
4> stop the configuredGrantTimer for the corresponding HARQ process of the de-prioritized uplink grant(s);
4> stop the cg-RetransmissionTimer for the corresponding HARQ process of the de-prioritized uplink grant(s).
3> consider the other overlapping SR transmission(s), if any, as a de-prioritized SR transmission(s).

Only PUCCH resources on a BWP which is active at the time of SR transmission occasion are considered valid.

As long as at least one SR is pending, the MAC entity shall for each pending SR:
1> if the MAC entity has no valid PUCCH resource configured for the pending SR:
2> initiate a Random Access procedure (see clause 5.1) on the SpCell and cancel the pending SR.
1> else, for the SR configuration corresponding to the pending SR:
2> when the MAC entity has an SR transmission occasion on the valid PUCCH resource for SR configured; and
2> if sr-ProhibitTimer is not running at the time of the SR transmission occasion; and
2> if the PUCCH resource for the SR transmission occasion does not overlap with a measurement gap:
3> if the PUCCH resource for the SR transmission occasion overlaps with neither a UL-SCH resource whose simultaneous transmission with the SR is not allowed by configuration of simultaneousPUCCH-PUSCH or simultaneousPUCCH-PUSCH-SecondaryPUCCHgroup nor an SL-SCH resource or simultaneousPUCCH-PUSCH-differentPUCCHgroup; or
3> if the MAC entity is able to perform this SR transmission simultaneously with the transmission of the SL-SCH resource; or
3> if the MAC entity is configured with Ich-basedPrioritization, and the PUCCH resource for the SR transmission occasion does not overlap with the PUSCH duration of an uplink grant received in a Random Access Response or with the PUSCH duration of an uplink grant addressed to Temporary C-RNTI or with the PUSCH duration of a MSGA payload, and the PUCCH resource for the SR transmission occasion for the pending SR triggered as specified in clause 5.4.5 overlaps with any other UL-SCH resource(s), and the physical layer can signal the SR on one valid PUCCH resource for SR, and the priority of the logical channel that triggered SR is higher than the priority of the uplink grant(s) for any UL-SCH resource(s) where the uplink grant was not already de-prioritized and its simultaneous transmission with the SR is not allowed by configuration of simultaneousPUCCH-PUSCH or simultaneousPUCCH-PUSCH-SecondaryPUCCHgroup or simultaneousPUCCH-PUSCH-differentPUCCHgroup, and the priority of the uplink grant is determined as specified in clause 5.4.1; or
   (omitted)

The RRC configuration simultaneousPUCCH-PUSCH-differentPUCCHgroup-r17 is introduced in PhysicalCellGroupConfig of TS38.331. In some embodiments, e.g., as described below,

```
    [[
    simultaneousPUCCH-PUSCH-differentPUCCHgroup-r17
    ENUMERATED {enabled}
OPTIONAL, -- Cond twoPUCCHgroup
    ]]
  simultaneousPUCCH-PUSCH-differentPUCCHgroup
  Enables simultaneous SR and PUSCH transmissions in different
  PUCCH groups.
```

simultaneousTransmissionPUCCH-PUSCH-r17 is introduced in TS38.331 UE capability. For example, it may be in MAC capability parameters (MAC-parameters). For example, as described below,

```
  simultaneousTransmissionPUCCH-PUSCH-r17 ENUMERATED
  { supported }
OPTIONAL
```

simultaneousTransmissionPUCCH-PUSCH-r17 is introduced in TS38.306 UE capability. For example, it may be in MAC capability parameters (MAC-parameters). For example, as described below,

| | | | | |
|---|---|---|---|---|
| simultaneousTransmissionPUCCH-PUSCH-r17 | UE | No | No | No |
| Indicates whether the UE supports simultaneous | | | | |
| transmission of SR and PUSCH in different PUCCH | | | | |
| groups as specified in TS 38.321 [8]. | | | | |

For Embodiment 1 (a UE reports assistance information), the specific implementation procedure is as follows:
1. The UE reports the assistance information to the network. Specifically, at least one of the following may be included.
1) The network is a base station, or a base station corresponding to a serving cell/Pcell/Pscell of the UE, or the serving cell/Pcell/Pscell of the UE.
2) The UE is an R18 UE, or a UE with a network energy saving purpose, or a UE indicated by a UE to report the assistance information.
3) The UE reports the assistance information in the case that the NW requests the assistance information or the UE receives a network indication for reporting the assistance information.
4) The assistance information is configured for network energy saving, or configured to perform network energy saving, or configured to acquire traffic or traffic-related information, or configured to ensure traffic transmission performance under the condition of ensuring network energy saving, or configured to achieve network energy saving and maintain network performance, or configured to select or configure network energy saving parameters or technologies.
5) The assistance information includes at least one of the following:
Traffic information, such as traffic characteristics (e.g., period, arrival time, data size, etc.).
Recommended base station or cell on/off information, which may specifically include at least one of the following: an indication request for cell or base station on/off, an on/off time (e.g., including at least one of a pattern (e.g., at least one of an on-off pattern or an off-on pattern, on/off time periods or a time distribution in a pattern, and a period of a pattern), an off duration, an on duration, an on start time, an off start time, an on end time, an off end time, a sequence of turning on and turning off, an on period, and an off period).

Recommended base station or cell DTX/DRX information, which may specifically include at least one of the following: a cell or base station DTX indication, a cell or base station DTX configuration (including at least one of a DTX cycle, a DTX pattern, DTX on information and/or DTX off information, a DT on duration, a DTX off duration, a sequence of turning on and turning off DTX in a DTX cycle, a sequence of turning on and turning off DTX in a DTX pattern, a DTX start offset (a DTX start time point), a DTX on start time, and a DTX off start time), a cell or base station DRX indication, a cell or base station DRX configuration (including at least one of a DRX cycle, a DRX pattern, DRX on information and/or DRX off information, a DRX on duration, a DRX off duration, a sequence of turning on and turning off DRX in a DTX cycle, a sequence turning on and turning off of DRX in a DTX pattern, a DRX start offset (a DRX start time point), a DRX on start time, and a DRX off start time).
In some embodiments, the DTX/DRX configuration or pattern includes at least one cycle, such as including a long cycle and/or a short cycle.
In some embodiments, the DTX/DRX cycle or pattern includes at least one on/off configuration, such as a long on configuration/a short off configuration, such as different on/off start times, such as different on/off durations.
In some embodiments, in the DTX/DRX cycle or pattern, “on” is before “off” (similar to the existing configuration or usage of UE DRX).
Recommended UE DTX/DRX information, which may specifically include at least one of the following: a UE DTX request, a UE DTX configuration recommendation (including at least one of a DTX cycle, a DTX pattern, DTX on information and/or DTX off information, a DTX on duration, a DTX off duration, a sequence of turning on and turning off DTX in a DTX cycle, a sequence of turning on and turning off DTX in a DTX pattern, a DTX start offset (a DTX start time point), a DTX on start time, or a DTX off start time), a UE DRX request, a UE DRX configuration recommendation (including at least one of a DRX cycle, a DRX pattern, DRX on information and/or DRX off information, a DRX on duration, a DRX off duration, a sequence of turning on and turning off DRX in a DTX cycle, a sequence of turning on and turning off DRX in a DTX pattern, a DRX start offset (a DRX start time point), a DRX on start time, or a DRX off start time).
In some embodiments, the DTX/DRX configuration or pattern includes at least one cycle, such as including a long cycle and/or a short cycle.
In some embodiments, the DTX/DRX cycle or pattern includes at least one on/off configuration, such as a long on configuration/a short off configuration, such as different on/off start times, such as different on/off durations.
In some embodiments, in the DTX/DRX cycle or pattern, “on” is before “off”.
An indication or request for the network to transition the cell state, or an indication or request for the network to perform network state transition, which may specifically include at least one of the following: a switch indication, and a switch duration (at least one of a start, a duration, and an end).
An indication or request for the network to enter a DRX and/or DTX state, which may specifically include at least one of the following: a DRX and/or DTX state indication, or a duration of the DRX and/or DTX state (at least one of a start, a duration, or an end).
A requested pattern of a network state. In some embodiments, the network state is two or more network states, such as on/off, such as on/off/DRX/DTX, such as low, medium, and high load states.

The assistance information may be reported by the UE by using at least one of a UL RRC message, a MAC CE, and UCI. In some embodiments, the UL RRC message is: a dedicated RRC message, or a UE assistance information message (e.g., a UEAssistanceInformation message).

The UE reports the assistance information and/or starts an assistance information reporting timer for the assistance information (in some embodiments, the assistance information is only reported in the case that the timer is not running) in at least one of the following cases: the UE is instructed to report the assistance information, a property of the UE changes (e.g., a traffic property changes, a preference of the UE changes (e.g., whether energy saving is required, whether an energy saving requirement is prioritized, whether a performance requirement is prioritized, etc.)), the UE has not transmitted relevant assistance information (e.g., a UEAssistanceInformation message) since the terminal is configured to report; and the current value is different from the value indicated in the last transmission of the relevant assistance information (e.g., the UEAssistanceInformation message).

2. The network receives the assistance information reported by the UE.

3. In some embodiments, the network achieves the purpose of network energy saving or selects or indicates a network energy saving technology or configuration based on the assistance information reported by the UE.

The beneficial effects are as follows. The UE reports the assistance information, such that the transmission performance requirement can be ensured while ensuring the network energy saving. The embodiment can be used alone, or used in combination with other embodiments in this solution.

For Embodiment 2 (data and/or signaling transmission for a network configuration or a network state), the specific implementation procedure is as follows (applicable to UL and/or DL):

1. The UE performs the data and/or signaling transmission based on the network state. Specifically, at least one of the following may be included.

1) The UE performs the data and/or signaling transmission based on information of the network configuration, or the network state.

2) The network state is a base station state or a cell state. In some embodiments, the cell state is: a state of a serving cell/Pcell/Pscell/neighbor cell of the UE, and the base station state is: a state of a base station corresponding to the serving cell/Pcell/Pscell/neighbor cell of the UE.

3) In some embodiments, the network state is two or more network states, such as on/off, such as on/off/DRX/DTX, such as low, medium, and high load states.

4) The UE is an R18 UE, or a UE with a network energy saving purpose, or a UE indicated by a UE to report the assistance information, or a UE that has reported the UE assistance information.

5) The UE performs the data and/or signaling transmission based on the network state, which may be a behavior performed by the UE as indicated or enabled by the NW, and/or a behavior performed by the UE in the case that the UE reports the assistance information (as in Embodiment 1, for example, where the UE has reported the assistance information in this case).

6) The UE performs the data and/or signaling transmission based on the network state, which includes at least one of the following:

The UE does not perform the data and/or signaling transmission, or transmits based on an X^{th} configuration (an enlarged configuration or interval) or based on cell/gNB DRX/DTX in the case that the cell/base station is off.

The UE performs the data and/or signaling transmission or performs the data and/or signaling transmission based on a default configuration in the case that the cell/base station is on.
In the case of cell/base station DTX, the UE performs the data and/or signaling reception in the case that the cell/base station DTX is on, and/or does not perform the data and/or signaling reception or performs the data and/or signaling reception based on an X^{th} configuration (e.g., an enlarged configuration or interval) in the case that the cell/base station DTX is off. Alternatively, in the case of cell/base station DTX, the UE performs the data and/or signaling reception using an X^{th} configuration (e.g., an enlarged configuration or interval).
performing data transmission at cell DTX on state or enlarge the data transmission interval.
In the case of cell/base station DRX, the UE performs the data and/or signaling transmission in the case that the cell/base station DRX is on, and/or does not perform the data and/or signaling transmission or performs the data and/or signaling transmission based on an X^{th} configuration (e.g., an enlarged configuration or interval) in the case that the cell/base station DRX is off. Alternatively, in the case of cell/base station DRX, the UE performs the data and/or signaling reception using an X^{th} configuration (e.g., an enlarged configuration or interval).
performing data transmission at cell DRX on state or enlarge the data transmission interval.

7) The data and/or signaling includes at least one of the following: common information/signaling, or UE-specific information/signaling/data.

In some embodiments, the information includes at least one of the following: a synchronization signal block (SSB), a SIB1, other SIBs, a reference signal (RS), a physical downlink control channel (PDCCH), a physical uplink control channel (PUCCH), downlink data, uplink data, a physical random access channel (PRACH), a dynamic scheduling resource (DG), a semi-persistent scheduling (SPS), a configured grant (CG), and a scheduling request (SR).

2. Before the first step, or after the first step, the UE acquires the network state, or an updated network state.

1) In some embodiments, the network state includes at least one of the following: a cell on/off indication, a base station on/off indication, a cell identification, a base station identification, a cell/gNB DTX indication, a cell/gNB DRX indication, information of base station or cell on/off (as in Embodiment 1), or a base station or cell DRX/DTX configuration (as in Embodiment 1).

2) In some embodiments, the network state is an implicit network state, that is, the network indicates an energy saving technology or configuration used, and the energy saving technology will be configured to correspond to the corresponding network state.

For example, an extended parameter configuration corresponds to the DTX/DRX state, or a medium load state.

For example, indicating to transmit the first information based on the first configuration is a DTX/DRX state or a medium load state. The first information includes at least one of the following: a synchronization signal block (SSB), an SIB1, other SIBs, a reference signal (RS), a physical downlink control channel (PDCCH), a physical uplink control channel (PUCCH), downlink data, uplink data, a physical random access channel (PRACH), a dynamic scheduling resource (DG), a semi-persistent scheduling (SPS), a configured grant (CG), or a scheduling request (SR).

For example, indicating not to transmit the first information is an off state. The first information includes at least one of the following: a synchronization signal block (SSB), an SIB1, other SIBs, a reference signal (RS), a physical downlink control channel (PDCCH), a physical uplink control channel (PUCCH), downlink data, uplink data, a physical random access channel (PRACH), a dynamic scheduling resource (DG), a semi-persistent scheduling (SPS), a configured grant (CG), or a scheduling request (SR).

3) In some embodiments, the network state is an implicit network state, that is, the network indicates information transmitted/sent/received. The information includes at least one of the following: common information/signaling, or UE-specific information/signaling/data.

In some embodiments, the information includes at least one of the following: a synchronization signal block (SSB), a SIB1, other SIBs, a reference signal (RS), a physical downlink control channel (PDCCH), a physical uplink control channel (PUCCH), downlink data, uplink data, a physical random access channel (PRACH), a dynamic scheduling resource (DG), a semi-persistent scheduling (SPS), a configured grant (CG), or a scheduling request (SR).

The beneficial effects are as follows. The UE performs different transmission modes based on the network state to achieve the purpose of network energy saving. The embodiment can be used alone, or used in combination with other embodiments in this solution, for example, in combination with Embodiment 1.

For Embodiment 3 (the network configures a cell or base station DRX/DTX configuration):

The specific implementation procedure is as follows (applicable to UL and/or DL):

1. The network configures or indicates the cell/gNB DTX and/or DRX configuration. Specifically, at least one of the following may be included.

1) The cell/gNB DTX and/or DRX configuration is determined based on a network state and/or a traffic transmission requirement.

In some embodiments, the network state is a base station state or a cell state. In some embodiments, the cell state is a state of a serving cell/Pcell/Pscell/neighbor cell of the UE, and the base station state is a state of a base station corresponding to the serving cell/Pcell/Pscell/neighbor cell of the UE.

In some embodiments, the network state is two or more network states, such as on/off, on/off/DRX/DTX, or low/medium/high load states.

2) The cell/gNB DTX and/or DRX configuration is used for a UE to transmit data and/or signaling.

Specifically, the data and/or signaling may be predefined, default, or indicated by the network. In some embodiments, the data and/or signaling is as described in the second step of the embodiment.

3) The cell/gNB DTX and/or DRX configuration may include at least one of the following:
a cell or base station DTX indication, a cell or base station DTX configuration (including at least one of a DTX cycle, a DTX pattern, DTX on information and/or DTX off information, a DTX on duration, a DTX off duration, a sequence of turning on and turning off DTX in a DTX cycle, a sequence of turning on and turning off DTX in a DTX pattern, a DTX start offset (a DTX start time point), a DTX on start time, or a DTX off start time), a cell or base station DRX indication, or a cell or base station DRX configuration (including at least one of a DRX cycle, a DRX pattern, DRX on information and/or DRX off information, a DRX on duration, a DRX off duration, a sequence of turning on and turning off DRX in a DTX cycle, a sequence of turning on and turning off DRX in a DTX pattern, a DRX start offset (a DRX start time point), a DRX on start time, or a DRX off start time).
In some embodiments, the DTX/DRX configuration or pattern includes at least one cycle, such as including a long cycle and/or a short cycle.
In some embodiments, the DTX/DRX cycle or pattern includes at least one on/off configuration, such as a long on configuration/a short off configuration, such as different on/off start times, such as different on/off durations.
In some embodiments, in the DTX/DRX cycle or pattern, “on” is before “off” (similar to the existing configuration or usage of UE DRX).

2. The UE performs data and/or signaling transmission based on the configured or indicated cell/gNB DTX and/or DRX configuration.

1) The UE is an R18 UE, or a UE with a network energy saving purpose, or a UE indicated by a UE to report the assistance information, or a UE that has reported the UE assistance information.

2) The UE performs the data and/or signaling transmission, which includes at least one of the following:

The UE performs the data and/or signaling reception in the case that the cell/base station DTX is on, and/or does not perform the data and/or signaling reception or performs the data and/or signaling reception based on an X^{th} configuration (e.g., an enlarged configuration or interval) in the case that the cell/base station DTX is off. Alternatively, in the case of cell/base station DTX, the UE performs the data and/or signaling reception by using an X^{th} configuration (e.g., an enlarged configuration or interval).
performing data transmission at cell DTX on state or enlarge the data transmission interval.

The UE performs the data and/or signaling transmission in the case that the cell/base station DRX is on, and/or does not perform the data and/or signaling transmission or performs the data and/or signaling transmission based on an X^{th} configuration (e.g., an enlarged configuration or interval) in the case that the cell/base station DRX is off. Alternatively, in the case of cell/base station DRX, the UE performs the data and/or signaling reception by using an X^{th} configuration (e.g., an enlarged configuration or interval).
performing data transmission at cell DRX on state or enlarge the data transmission interval.

The data and/or signaling includes at least one of the following: common information/signaling, and UE-specific information/signaling/data.
In some embodiments, the information includes at least one of the following: a synchronization signal block (SSB), a SIB1, other SIBs, a reference signal (RS), a physical downlink control channel (PDCCH), a physical uplink control channel (PUCCH), downlink data, uplink data, a physical random access channel (PRACH), a dynamic scheduling resource (DG), a semi-persistent scheduling (SPS), a configured grant (CG), or a scheduling request (SR).

In some embodiments, the network indicates the data and/or signaling influenced by the cell/gNB DTX and/or DRX configuration. That is, only default, or network-indicated, or pre-configured data and/or signaling is transmitted based on the DTX and/or DRX configuration or indication.

3) In some embodiments, the UE is also indicated with the network state, or an updated network state.

The beneficial effects are as follows. The DRX and/or DTX configuration of the network or the cell is introduced, such that the UE performs transmission based on the configuration to achieve the purpose of network energy saving. The embodiment can be used alone, or used in combination with other embodiments in this solution, for example, in combination with Embodiment 1 and Embodiment 2.

For Embodiment 4 (a method for BWP switching):

Note: the method of the embodiment is also applicable to Pcell switch and Scell reactivation.

The specific implementation procedure is as follows:

1. The network indicates, either explicitly or implicitly, a UE to perform BWP switching based on first information. Specifically, at least one of the following may be included.

a) Indicating the UE to perform the BWP switching may also be indicating the UE to switch from a first BWP to a second BWP.

b) The switched BWP or the second BWP is a default BWP, or a previous BWP (for example: a BWP before switching to the first BWP, e.g., a BWP before the BWP switching indication, e.g., a BWP used at the time or in the case of reception of the first information and/or the second information), or a specific BWP (e.g., at least one of the following: a network energy saving BWP, a non-energy saving BWP, a BWP with a specific identifier, such as a BWP index, and an initial BWP), or a BWP indicated in the first information, or a BWP indicated by the second information (e.g., the first information is carried in group information (e.g., a group RNTI, group DCI, or a group MAC CE) and the second information is carried in a SIB, or the first information is carried in a SIB and the second information is carried in group information (e.g., a group RNTI, group DCI, or a group MAC CE)).

c) The first information may include at least one of the following:
i. a BWP switching indication;
ii. a network state indication or a network state change;
iii. a switched BWP identifier;
iv. a network load condition; or
v. whether the network energy saving is prioritized, or whether transmission performance is prioritized.

d) The first information is received via a common search space, or via a terminal-specific search space (UE-specific search space), or via a specific search space (configured by the network, or predefined; in addition, in some embodiments, the common search space and/or the UE-specific search space is shared, or configured independently).
i. For example, it is all received via the common search space.
ii. For example, it is all received via the terminal-specific search space.
iii. For example, it is all received via the specific search space.
iv. For example, in the case of a low or no network load, or in the case that the network state is a first state (e.g., no load, a low load, base station or cell DRX, base station or cell DTX, an energy saving state, etc.), or in the case that the UE acquires the low or no network load, or in the case that the UE acquires that the network state is the first state (e.g., no load, a low load, base station or cell DRX, base station or cell DTX, an energy saving state, etc.), the reception is performed via the common search space, or via the specific search space.
v. For example, in the case of a high network load, or in the case that the network state is a second state (e.g., a high load, a non-energy saving state, etc.), or in the case of normal transmission, or in the case that the UE acquires the high network load, or in the case that the UE acquires that the network state is the second state (e.g., a high load, a non-energy saving state, etc.), or in the case that the UE acquires the normal transmission, the reception is performed via the terminal-specific search space, or via the specific search space.
vi. For example, the UE switches to the BWP to be switched based on the BWP information (e.g., a BWP index to which the network indicates to switch) indicated by the network in the first information and/or the second information.
vii. For example, in the case of a low or no network load, or in the case that the network state is a first state (e.g., no load, a low load, base station or cell DRX, base station or cell DTX, an energy saving state, etc.), or in the case that the UE acquires the low or no network load, or in the case that the UE acquires that the network state is the first state (e.g., no load, a low load, base station or cell DRX, base station or cell DTX, an energy saving state, etc.), or the UE is instructed to perform the BWP switching (e.g., an indicator bit for the BWP switching is present, and the BWP index may or may not be given), the UE switches to BWP A. The BWP A may be at least one of the following: a default BWP (e.g., default BWP 1, as predefined, or indicated by the network over the SIB), a specific BWP (e.g., at least one of the following: a network energy saving BWP, a BWP with a specific identifier, such as a BWP index (e.g., with a minimum index, e.g., index 0), an initial BWP), a small bandwidth BWP, a previous BWP (e.g., a first BWP, or a BWP used at the time of reception of the BWP switching indication or the first information indication, or a BWP used before a currently used or activated BWP), and a large bandwidth BWP.

For example, in the case that the network indicates to which BWP each UE is to switch, problems with switch delay and network overhead may be generated. This problem can be solved by the UE switching to the original BWP autonomously.

For example: if the gNB knows the no/small traffic load, the gNB could switch all or most UEs to the same bandwidth part with a small bandwidth. Such BWP switch can be indicated to the UE via one group common DCI.

a) UE can switch to the BWP indicated by network, or, UE can autonomously switch to the initial BWP, or, the index M BWP, or, the BWP defined for energy saving.

viii. For example, in the case of a high network load, or in the case that the network state is a second state (e.g., a high load, or a non-energy saving state, etc.), or in the case of normal transmission, or in the case that the UE acquires the high network load, or in the case that the UE acquires that the network state is the second state (e.g., a high load, a non-energy saving state, etc.), or in the case that the UE acquires the normal transmission, or the UE is instructed to perform the BWP switching (e.g., an indicator bit for the BWP switching is present, and the BWP index may or may not be given), the UE switches to BWP B. The BWP B may be at least one of the following: a default BWP (e.g., default BWP 2, as predefined, or indicated by the network over the SIB), a specific BWP (e.g., at least one of the following: a non-network energy saving BWP, a BWP without a specific identifier, such as a BWP index (e.g., an index other than an index 0 or a minimum index), a BWP with a specific identifier, such as a BWP index (e.g., with a maximum index), a non-initial BWP), a previous BWP (e.g., a BWP before switching to a first BWP, or the first BWP, or a BWP used at the time of reception of the BWP switching indication or the first information indication, or a BWP used before a currently used or activated BWP), and a large bandwidth BWP.

For example, in the case that the network indicates to which BWP each UE is to switch, problems with switch delay and network overhead may be generated. This problem can be solved by the UE switching to the original BWP autonomously.

For example: if the network traffic load changes to larger, the activated BWP for each UE can be adapted accordingly. For example, the UE can autonomous switch to the previous BWP (when the BWP switching indication is received) or the UE switches to the BWP with large bandwidth which is explicitly indicated by the network.

e) The UE is a UE accessing a current cell, or a UE residing in the current cell, or a UE configured/designated to a specific group, or a UE with a network energy saving capability, or a UE having reported a network energy saving capability or requirement.

f) The first information may further include at least one of the following: a switching time or a switching delay offset.

g) In some embodiments, the first information is carried by an SIB, or carried in first information. The first information may be group DCI or group RNTI scrambled DCI, or a PDSCH scheduled by the group DCI or the group RNTI scrambled DCI (for example, in an RAR manner).
For example, a MAC PDU carries one or more MAC sub-PDUs, and each MAC sub-PDU corresponds to a piece of UE-specific information.
For example, the MAC PDU carries one or more MAC sub-PDUs, and each MAC sub-PDU corresponds to information of a UE group.
For example, the MAC PDU carries one or more MAC sub-PDUs, and each MAC sub-PDU corresponds to information of a cell level.

2. The UE performs the BWP switching. In some embodiments, two solutions are provided.

a) In a first solution, the terminal performs the BWP switching in response to receiving the first information.

b) In a second solution, the terminal performs the BWP switching at an indicated switching time, or at the time of first information reception/decoding+offset duration, in response to receiving the first information.

The beneficial effects are as follows. A method for BWP switching is introduced for different network loads. Alternatively, a unified or specific method for BWP switching is given according to whether network energy saving is required. The embodiment can be used alone, or used in combination with other embodiments in this solution, for example, in combination with Embodiment 1, and the like.

For Embodiment 5 (a method for DRX use, or a method for DRX parameter change or use):

The specific implementation procedure is as follows (applicable to UL and/or DL):

1. The network configures a DRX parameter or configuration.

a) The DRX parameter or configuration is specific to the UE (rather than the cell).

2. The UE receives the DRX parameter or configuration configured by the network and performs DRX transmission or reception.

3. The UE performs an updated DRX parameter or configuration based on the network indication information, or performs transmission based on the updated DRX parameter or configuration. Specifically, at least one of the following may be included.

a) The DRX parameter or configuration may be all or a part of the existing DRX parameters, or all or a part of DRX parameters newly added in subsequent versions.

b) For example, the network configures a plurality of sets of DRX parameters or configurations, corresponding to different indexes. The UE performs data transmission based on the DRX parameter or the configured index indicated by the network according to the value corresponding to the DRX parameter or the configured index indicated by the network.

i. Specifically, the plurality of sets of DRX parameters or configurations are two sets, and the UE directly switches between the two sets (for example, the UE can switch between the two sets as long as receiving a DRX parameter or a configuration switch indication, or receiving an update indication for the network state or the network load or whether to save energy).

ii. For example, a DRX parameter or configuration with a short on duration or a long cycle is used in the case of energy saving. For example, a DRX parameter or configuration with a long on duration or a short cycle is used in the case of non-energy saving.

c) For example, the network configures a plurality of sets of DRX parameters or configurations, and different configurations correspond to different network states or network loads or requirements on whether to save energy. The UE determines the used DRX parameter or configuration based on the network state or network load or requirement on whether to save energy indicated by the network, and performs data transmission.

d) For example, the network configures a set of DRX parameters or configurations corresponding to a network state (e.g., a low load, energy saving, cell DRX/DTX, etc.) or a network load (e.g., a low load, no load, etc.) or a requirement on whether to save energy. The UE determines whether to use the DRX parameter or configuration based on the network state or network load or requirement on whether to save energy indicated by the network, and performs data transmission.

e) For example, the network indicates an update of the DRX parameter or configuration at the cell or UE group level over common DCI or a common MAC CE or system information or the content of the PDSCH carried by the common DCI. The UE performs transmission using the updated configuration based on the update.

The beneficial effects are as follows. A method for using or updating DRX parameters based on an energy saving requirement or a network state is introduced. The complexity or delay can be reduced while the network energy saving is achieved. The embodiment can be used alone, or used in combination with other embodiments in this solution, for example, in combination with Embodiment 1, and the like.

For Embodiment 6 (a method for implementing UE group or cell level handover):

The specific implementation procedure is as follows.

1. The base station switches the UE(s) to a second cell in a group handover or cell level handover manner. Specifically, at least one of the following may be included.

a) For example, in the case that a current serving cell is off, or in the case of energy saving, or in the case of a low or no network load, the UE is switched to the second cell.

b) A parameter or configuration of the group handover or cell level handover includes a common part and/or a terminal-specific (UE-specific) part.

i. The common part is carried in an SIB. Alternatively, the common part is carried in first information, and the terminal-specific part is carried in second information. Alternatively, the common part is carried in the first information together with the terminal-specific part. The first information may be group DCI or group RNTI scrambled DCI, or a PDSCH scheduled by the group DCI or the group RNTI scrambled DCI (for example, in an RAR manner). The second information is a PDSCH scheduled by the group DCI or the group RNTI scrambled DCI (for example, in an RAR manner).
For example, a MAC PDU carries one or more MAC sub-PDUs, and each MAC sub-PDU corresponds to terminal-specific information. In some embodiments, the MAC PDU further carries one or more MAC sub-PDUs carrying common information.
In some embodiments, the terminal-specific information is specific to each UE, or specific to UEs at certain locations (e.g., different locations, or different coordinate intervals).
In some embodiments, the common information is specific to all UEs in a cell, or specific to UEs at certain locations, or specific to UEs of a certain group.

a) For example, “common” is specific to a cell, and “terminal-specific” is specific to UEs at certain locations.

b) For example, “common” is specific to a UE group, and “terminal-specific” is specific to a certain UE.

c) For example, “common” is specific to a cell, and “terminal-specific” is specific to a certain UE group.

2. The UE performs handover based on the handover information.

The beneficial effects are as follows. A method for group handover in a network energy saving condition is provided, which achieves the purpose of energy saving and reduces the delay/overhead.

The methods for saving energy according to the above embodiments may be used alone to implement network energy saving, or used in combination to implement network energy saving.

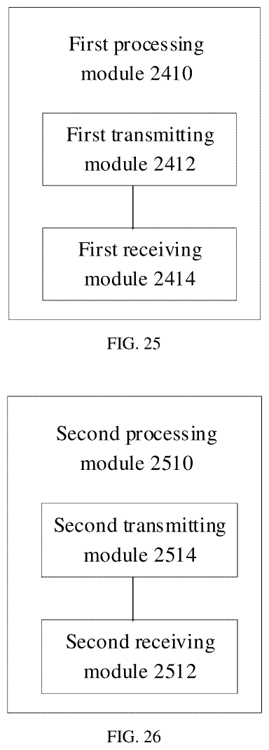

FIG. 25 illustrates an apparatus for saving energy according to some embodiments of the present disclosure, which includes at least some of a first processing module 2410, a first transmitting module 2412, and a first receiving module 2414, for example, in the case that the apparatus is applied to a terminal.

The first transmitting module 2412 is configured to perform the steps associated with transmission as performed by the terminal side in the above embodiments; the first receiving module 2414 is configured to perform the steps associated with reception as performed by the terminal side in the above embodiments; and the first processing module 2410 is configured to perform the steps associated with transmission, reception, and processing as performed by the terminal side in the above embodiments, where the processing includes all or a part of data processing associated with the transmission step, data processing associated with the reception step, and other data processing unassociated with transmission or reception, which are not repeated herein.

The relevant steps performed by the apparatus according to the embodiments may refer to the method embodiments described above.

In summary, the apparatus according to the embodiments achieves network energy saving by performing operations associated with the network energy saving. Due to the fact that the operations associated with the network energy saving under various scenarios and requirements are supported, the flexibility, reliability, and efficiency of the network energy saving are greatly improved.

FIG. 26 illustrates an apparatus for saving energy according to some embodiments of the present disclosure, which includes at least some of a second processing module 2510, a second receiving module 2512, and a second transmitting module 2514, for example, in the case that the apparatus is applied to a network.

The second transmitting module 2514 is configured to perform the steps associated with transmission as performed by the network side in the above embodiments; the second receiving module 2512 is configured to perform the steps associated with reception as performed by the network side in the above embodiments; and the second processing module 2510 is configured to perform the steps associated with transmission, reception, and processing as performed by the network side in the above embodiments, where the processing includes all or a part of data processing associated with the transmission step, data processing associated with the reception step, and other data processing unassociated with transmission or reception, which are not repeated herein.

The relevant steps performed by the apparatus according to the embodiments may refer to the method embodiments described above.

In summary, the apparatus according to the embodiments achieves network energy saving by performing operations associated with the network energy saving. Due to the fact that the operations associated with the network energy saving under various scenarios and requirements are supported, the flexibility, reliability, and efficiency of the network energy saving are greatly improved.

It should be noted that, for the apparatus provided in the embodiments described above, the division of the functional modules is merely exemplary. In practical applications, the functions described above can be assigned to different functional modules as needed, that is, the internal structure of the device can be divided into different functional modules, so as to implement all or a part of the above functions.

With regard to the apparatus in the embodiments, the specific manner in which each module performs operations has been described in detail in the embodiments related to the method and will not be described in detail herein.

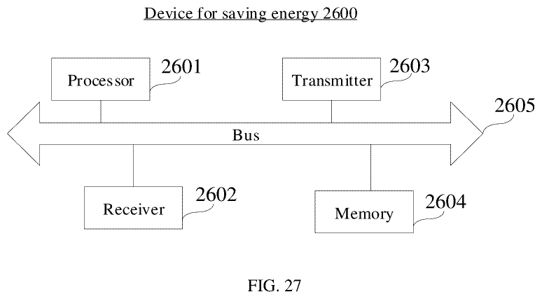

FIG. 27 illustrates a schematic structural diagram of a device for saving energy (a terminal or a network device) according to some embodiments of the present disclosure. The device for saving energy 2600 includes: a processor 2601, a receiver 2602, a transmitter 2603, a memory 2604, and a bus 2605.

The processor 2601 includes one or more processing cores, and the processor 2601 performs various functional applications and information processing by running software programs and modules. In some embodiments, the processor 2601 is configured to implement the functions and steps of the first processing module 2410 and/or the second processing module 2510 described above.

The receiver 2602 and the transmitter 2603 can be implemented as a communication assembly, which can be a communication chip. In some embodiments, the receiver 2302 is configured to implement the functions and steps of the first receiving module 2414 and/or the second receiving module 2512 as described above. In some embodiments, the transmitter 2603 is configured to implement the functions and steps of the first transmitting module 2412 and/or the second transmitting module 2514 as described above.

The memory 2604 is connected to the processor 2601 via the bus 2605. The memory 2604 is configured to store at least one instruction, and the processor 2601 is configured to execute the at least one instruction to perform the steps in the above method embodiments.

In addition, the memory 2604 may be implemented by any type or combination of transitory or non-transitory storage devices including, but not limited to: magnetic or optical disks, electrically erasable programmable read-only memories (EEPROMs), erasable programmable read-only memories (EPROMs), static random access memories (SRAMs), read-only memories (ROMs), magnetic memories, flash memories, and programmable read-only memories (PROMs).

In some embodiments, the receiver 2602 independently receives signals/data, or the processor 2601 controls the receiver 2602 to receive signals/data, or the processor 2601 requests the receiver 2602 to receive signals/data, or the processor 2601 cooperates with the receiver 2602 to receive signals/data.

In some embodiments, the transmitter 2603 independently transmits signals/data, or the processor 2601 controls the transmitter 2603 to transmit signals/data, or the processor 2601 requests the transmitter 2603 to transmit signals/data, or the processor 2601 cooperates with the transmitter 2603 to transmit signals/data.

In some embodiments, a computer-readable storage medium is further provided. The computer-readable storage medium stores one or more runnable programs, where one or more runnable programs, when loaded and run by a processor of a communication device, cause the communication device to perform the method for saving energy as described in the above aspect.

In some embodiments, a chip is further provided. The chip includes one or more programmable logic circuits or one or more programs, where a communication device equipped with the chip is configured to perform the method for saving energy as described in the above aspect.

In some embodiments, a computer program product is further provided. The computer program product includes one or more computer programs stored in a computer-readable storage medium, where the one or more computer programs, when read by a processor of a communication device from the computer-readable storage medium and run by the processor, cause the communication device to perform the method for saving energy as described in the above aspect. The above embodiments may be used alone or in combination.

Those skilled in the art should appreciate that in one or more of the above embodiments, the functions described in the embodiments of the present disclosure may be implemented in hardware, software, firmware, or any combination thereof. The functions, when implemented using software, are stored in a computer-readable medium or transmitted as one or more instructions or codes on the computer-readable medium. The computer-readable medium includes a computer storage medium and a communication medium, where the communication medium includes any medium that facilitates the transfer of a computer program from one place to another. The storage medium is any available medium that is accessible by a general-purpose or special-purpose computer.

Described above are merely optional embodiments of the present disclosure and are not intended to limit the present disclosure. Any modifications, equivalent substitutions, improvements, and the like, made within the spirit and principle of the present disclosure should fall within the protection scope of the present disclosure.

1. A method for saving energy, applicable to a terminal, the method comprising:
performing an operation associated with network energy saving.

2. The method according to claim 1, wherein performing the operation associated with the network energy saving comprises:
performing data transmission and/or signaling transmission and/or system information transmission based on network configurations, wherein at least one of the network configurations is associated with the network energy saving; or
performing data transmission and/or signaling transmission and/or system information transmission based on the network states, wherein at least one of the network states is associated with the network energy saving; or
performing data transmission and/or signaling transmission and/or system information transmission based on a network state change, wherein at least one of network states before and after the network state change is associated with the network energy saving.

3. The method according to claim 2, wherein the network state comprises a cell state;
the cell state comprises at least one of: a state of a serving cell of the terminal, a state of a primary cell of the terminal, a state of a primary secondary cell of the terminal, a state of a neighbor cell of the terminal, a state of a cell of a neighbor base station of the base station, or a state of a cell of the base station in an ANR list.

4. The method according to claim 2, wherein the network state comprises at least one of network DRX state or a network DTX state.

5. The method according to claim 2, wherein performing the data transmission and/or the signaling transmission and/or the system information transmission based on the network states comprises:
performing the data transmission and/or the signaling transmission and/or the system information transmission based on the network states in a case that the network indicates the terminal.

6. The method according to claim 5, wherein performing the data transmission and/or the signaling transmission and/or the system information transmission based on the network states in the case that the network indicates the terminal comprises:
performing the data transmission and/or the signaling transmission and/or the system information transmission based on the network states or a network state change indication in a case that the network indicates the network states or a state change to the terminal.

7. The method according to claim 2, wherein performing the data transmission and/or the signaling transmission and/or the system information transmission based on the network states, comprises at least one of:
performing the data transmission and/or the signaling transmission and/or the system information transmission in a case that network DTX is on;
not performing the data transmission and/or the signaling transmission and/or the system information transmission in a case that network DTX is off;
performing the data transmission and/or the signaling transmission and/or the system information transmission in a case that network DRX is on; or
not performing data transmission and/or the signaling transmission and/or the system information transmission in a case that network DRX is off.

8. The method according to claim 1, wherein performing the operation associated with the network energy saving comprises:
performing the data transmission and/or the signaling transmission and/or the system information transmission based on a network DTX configuration and/or a network DRX configuration.

9. The method according to claim 2, wherein the data and/or the signaling and/or the system information is default, or indicated by the network, or pre-configured.

10. The method according to claim 8, wherein the network DTX configuration comprises at least one of:
a network DTX indication; or
a network DTX configuration parameter;
the network DRX configuration comprises at least one of:
a network DRX indication; or
a network DRX configuration parameter.

11. The method according to claim 10, wherein
the network DTX configuration parameter comprises at least one of: a DTX cycle, a DTX pattern, DTX on information, DTX off information, a DTX on duration, a DTX off duration, a sequence of turning on and turning off DTX in a DTX cycle, a sequence of turning on and turning off DTX in a DTX pattern, a DTX start offset, a DTX on start time, a DTX off start offset, or a DTX off start time; and
the network DTX configuration parameter comprises at least one of: a DRX cycle, a DRX pattern, DRX on information, DRX off information, a DRX on duration, a DRX off duration, a sequence of turning on and turning off DRX in a DRX cycle, a sequence of turning on and turning off DRX in a DRX pattern, a DRX start offset, a DRX on start time, a DRX off start offset, or a DRX off start time.

12. The method according to claim 2, wherein the data and/or signaling and/or system information comprises at least one of:
common information or signaling; or
terminal-specific information or signaling or data.

13. The method according to claim 12, wherein
the common information or signaling comprises at least one of: a synchronization signal block (SSB), a master information block (MIB), a system information block SIB1, other SIBs, a common reference signal (RS), or a physical random access channel (PRACH); and
the terminal-specific information or signaling or data comprises at least one of: a terminal-specific reference signal, a physical downlink control channel (PDCCH), a physical uplink control channel (PUCCH), downlink data, uplink data, a dynamic scheduling resource (DG), a semi-persistent scheduling (SPS), a configured grant (CG), or a scheduling request (SR).

14. The method according to claim 1, wherein performing the operations associated with the network energy saving comprises:
performing cell handover based on cell handover information;
wherein the cell handover information is terminal group handover information or cell level handover information.

15. The method according to claim 14, wherein the cell handover information comprises a handover parameter or configuration, and the handover parameter or configuration comprises: a common part and/or a terminal-specific part.

16. The method according to claim 15, wherein
the common part is carried in an SIB or first downlink information, and the terminal-specific part is carried in second downlink information; or
the common part and the terminal-specific part are both carried in the first downlink information.

17. The method according to claim 16, wherein the first downlink information comprises at least one of:
group downlink control information (DCI); or
group radio network temporary identifier (RNTI) scrambled DCI.

18. The method according to claim 1, wherein the terminal comprises at least one of:
a terminal in a first communication protocol version;
a terminal with a network energy saving purpose;
a terminal instructed to report an assistance information;
a terminal having reported assistance information;
a terminal accessing a current cell;
a terminal residing in the current cell;
a terminal configured to a specific group;
a terminal designated to the specific group;
a terminal having reported a network energy saving capability;
a terminal having reported a network energy saving requirement;
a connected state terminal; or
a non-connected state terminal.

19. A terminal, comprising:
a processor;
a transceiver, connected to the processor; and
a memory, configured to store one or more runnable programs of the processor;
wherein the processor, when loading and running the one or more runnable programs, is caused to:
perform an operation associated with network energy saving.

20. A network device, comprising:
a processor;
a transceiver, connected to the processor; and
a memory, configured to store one or more runnable programs of the processor;
wherein the processor, when loading and running the one or more runnable programs, is caused to:
perform an operation associated with network energy saving.
